(19) United States
(12) Patent Application Publication
(10) Pub. No.: US 2014/0065637 A1
(43) Pub. Date: Mar. 6, 2014

(54) Determining Information for Cells

(71) Applicant: KLA-Tencor Corporation, Milpitas, CA (US)

(72) Inventors: Gregory L. Kirk, Pleasanton, CA (US); Johan Christiaanse, San Jose, CA (US)

(73) Assignee: KLA-Tencor Corporation, Milpitas, CA (US)

(21) Appl. No.: 14/014,137

(22) Filed: Aug. 29, 2013

Related U.S. Application Data
(60) Provisional application No. 61/695,222, filed on Aug. 30, 2012.

(51) Int. Cl. G01N 21/64

(52) U.S. Cl. CPC G01N 21/6486
USPC 435/7.1; 435/288.7; 435/29

(57) ABSTRACT

Systems, methods, and devices for determining information for cells are provided. The systems, methods, and devices are configured such that information for more than 100,000 cells can be determined in a single run. The devices are configured to immobilize the cells. The devices also include features that can be used by the systems and methods for determining and tracking the positions of each of the cells in the device on a cell-by-cell basis. The systems and methods are configured for substantially high resolution of the cells while the cells are immobilized in the device. In addition, environmental control subsystems are provided that can control an environment of the cells while the device is positioned in the system or the method is being performed without altering positions of the cells within the device.

### BACKGROUND OF THE INVENTION

1. Field of the Invention

The present invention generally relates to systems, methods, and devices for determining information for cells.

2. Description of the Related Art

The following description and examples are not admitted to be prior art by virtue of their inclusion in this section.

The analysis of biological cells plays an important role in life science research. With the advances in science, it has become more important to identify and analyze larger numbers of cells faster and with greater precision. This analysis of biological cells is applied in areas such as in the basic understanding of the mechanisms of life, in the understanding of disease, and in the development of therapeutic drugs. In addition, cells themselves are becoming therapeutic agents for the treatment of disease.

Often, cells of interest appear in substantially low frequency in a total cell sample, making them hard to find and requiring lengthy procedures for their reliable detection and isolation. Scientists are not only interested in the detection and counting of rare cells in populations, but also need the ability to isolate them for further processing.

Currently available cytometry systems are limited in their throughput and ability to identify rare cell populations of interest in a timely manner. Flow cytometry has long been the method of choice for the detection and isolation of rare cell populations. In this technology, cells, suspended in liquid, are made to travel past a stationary sensing zone, where several cell properties can be measured. The user can select the characteristics of interest that identify the (rare) cells of interest and program the system to isolate these cells.

Flow cytometers have a number of detection limitations. For example, flow cytometers do not collect morphological data from the cells being analyzed. Morphological information can be an important differentiator that uniquely identifies the (rare) cell of interest. The more information from independent cell properties that can be detected, the easier it will be to uniquely identify (rare) cells of interest. In addition, most of the identification in a flow cytometer is accomplished with fluorescently labeled monoclonal antibodies. Currently, up to a dozen of those labels can be applied and detected at once in discrete detector systems where each detector detects the light in a specific portion of the total spectrum of light emitted by the collection of fluorescent dyes used to stain the cells. However, the spectral overlap of the dyes used makes setup of the analytical system complicated and limits the signal that can be detected from each probe. Ideally, the cell of interest that is intended to be isolated for further processing is kept alive and is not impacted by stains and dye mechanisms that are needed to identify it for isolation. Furthermore, morphological information and intrinsic fluorescent information cannot be detected in current flow cytometers. Moreover, theoretically, cells of interest can be reexamined after isolation with a flow cytometer. However, in practice, this process is limited due to the inefficiency of the sorting system described below and the fact that cells of interest can be lost in a relatively high volume of fluid after isolation, specifically when the cells of interest exist in relatively low concentration in the original sample. In addition, re-analysis of sorted cells will require manipulation of the sample, including centrifugation or other concentration steps, potentially resulting in the loss of those valuable (and possibly rare) cells.

Flow cytometers also have a number of throughput limitations. For example, the maximum speed of cell analysis in flow cytometers is on the order of 100,000 cells per second. Rare cell populations that are of interest to scientists may be present in frequencies as low as one in 1,000,000,000 cells. Current requirements for the detection of circulating tumor cells (CTC) in peripheral blood require the identification of 5 CTCs in up to 5×10⁹ cells, or close to 14 hours of analysis.

Flow cytometers also have a number of cell isolation limitations. For example, the recovery precision of the sorting mechanism of flow cytometry is limited. Therefore, a cell that was identified for isolation cannot be isolated and recovered with great certainty.

Accordingly, it would be advantageous to develop methods and systems for determining information for cells that do not have one or more disadvantages described above.

### SUMMARY OF THE INVENTION

The following description of various embodiments is not to be construed in any way as limiting the subject matter of the appended claims.

One embodiment relates to a system configured to determine information for cells. The system includes an environmental control subsystem configured to control an environment of cells immobilized in a device while the device is positioned in the system without altering positions of the cells within the device. The device has features used by the system for separately determining and tracking the positions of each of the cells in the device on a cell-by-cell basis. The system also includes an illumination subsystem configured to focus light to the cells immobilized in the device and the features. In addition, the system includes a detection subsystem configured to generate output responsive to light from the cells and the features. The system further includes a computer subsystem configured to correlate the cells individually with their positions within the device based on the output responsive to the light from the cells and the features and to determine one or more characteristics of the cells based on the output responsive to the light from the cells. The system may be further configured as described herein.

Another embodiment relates to a method for determining information for cells. The method includes controlling an environment of cells immobilized in a device while the device is being used for the method without altering positions of the cells within the device. The device has features used by the method for separately determining and tracking the positions of each of the cells in the device on a cell-by-cell basis. The method also includes focusing light to the cells immobilized in the device and the features of the device. In addition, the method includes generating output responsive to light from the cells and the features of the device. The method further includes correlating the cells individually with their positions within the device based on the output responsive to the light from the cells and the features. The method also includes determining one or more characteristics of the cells based on the output responsive to the light from the cells.

The method may also include classifying cells into groups based on these characteristics. The method may also include returning to locations of cells contained in selected groups and generating further output responsive to cells in manners similar to or different than those used prior to this step so that new characteristics can be determined or existing characteristics can be verified.

The method may also include treatment of the cells after the classification step above where selected cells from groups can be marked or stimulated for further output analysis.

The method may also include selecting cells based on original or subsequent output data and characteristics and returning to these cell locations and removing the cells for further analysis or processing. Preferably, this is performed while maintaining cell viability.

Each of the steps of the method described above may be further performed as described herein. In addition, the method described above may include any other step(s) of any other method(s) described herein. Furthermore, the method described above may be performed by any of the systems described herein.

An additional embodiment relates to a device configured to immobilize cells for analysis. The device includes a substrate configured to support one or more materials configured to immobilize the cells within the device. The device also includes features configured for use by an analysis system for separately determining and tracking positions of each of the cells in the device on a cell-by-cell basis. The substrate and the one or more materials are configured to not optically interfere with light focused to the cells and the features by the analysis system and light from the cells and the features detected by the analysis system. In addition, the device includes one or more structures configured to couple an environmental control subsystem to the device. The environmental control subsystem is configured to control an environment of the cells within the device while the device is positioned in the analysis system without altering the positions of the cells within the device. The device may be further configured as described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIG. 1 is a schematic diagram illustrating a top view of one embodiment of a device configured to immobilize cells for analysis;

FIGS. 2-5 are schematic diagrams illustrating side views of various embodiments of a device configured to immobilize cells for analysis;

FIG. 6 is a schematic diagram illustrating a top view of one embodiment of a device configured to immobilize cells for analysis;

FIG. 7 is a schematic diagram illustrating a top view and a side view of one embodiment of a device configured to immobilize cells for analysis;

FIGS. 8-9 are schematic diagrams illustrating side views of various embodiments of cell adhesion spots formed on a substrate of a device configured to immobilize cells for analysis;

FIGS. 10-1 are schematic diagrams illustrating side views of various embodiments of a device configured to immobilize cells for analysis;

FIGS. 12-16 are schematic diagrams illustrating side views of various embodiments of a system configured to determine information for cells;

FIGS. 17-20 are schematic diagrams illustrating side views of various embodiments of different portions of a system configured to determine information for cells and to selectively review, remove, and/or treat cells in a device; and

FIG. 21 is a flow chart illustrating one embodiment of a method for determining information for cells.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein provide high throughput cell imaging inspection, review, treatment, and sampling (selection or retrieval). There are several reasons why a relatively high throughput, large population imaging cytometry system is desirable. For example, disease research scientists desire to collect large databases correlating cell phenotype versus genotype from blood borne cells as well as tissue homogenate. Biological researchers understand that cell diversity and differentiation at the micro-scale is an important factor to study and thus requires extensive data collection from large cell populations. In addition, Pharma/BioPharma drug research scientists trying to discover targets for drugs often use or collect similar cell phenotype versus genotype databases. In particular, drug research for blood borne diseases lends itself to cytometry-based segmentation of disease-related cells. In another example, in the pre-clinical stages of drug discovery/development, scientists will often use ex-vivo tests to see if a drug is effective without risking toxicity to the patient, which often means measuring drug effects on specific cell sub-populations. There is also a very steep trend in “Theranostics,” a part of the personalized medicine trend, in which patients undergo extensive phenotype and genotype testing during the clinical trial phase of drug development so that a drug company can show that, for a specific sub-population of patients, the drug being tested is safer and more effective than the incumbent drug. In some of these Theranostics applications, it may be necessary to measure the effect of the drug on a sub-population of the cells from, say, a blood sample. Furthermore, a high throughput, large population imaging cytometry system would be beneficial for developing stem cells for use as testing platforms for drugs (e.g. to test organ toxicity) and as therapeutic regimens in which patient marrow cells are modified and certain cells are selected, grown and re-inserted into the patient for therapeutic benefit. Similarly, antibody (Ab) based drug researchers desire to identify and isolate B-cells in animal or human blood samples that secrete a particular Ab that can be tested to bind to a disease-related agent of interest. These B-cells may exist as a substantially small sub-population of the entire B-Cell population and would require significant imaging and analysis to classify and select. This modification, measurement, and selection process will be an important development in years to come. In addition, future disease diagnostics will involve much more complex readouts of blood samples. For example, circulating tumor cell (CTC) tests are being proposed to find less than 5 cells out of a 5 million cell population that may be from potentially metastasizing tumors that have shed tissues cells into the bloodstream and that are distinctly different, but with subtle differences, than the innate nucleated cells normally present in the blood sample.

There are a number of limitations in currently available large population cytometry. For example, flow cytometry has certain limitations. In particular, flow cytometers can cost from $200K to $500K. Therefore, flow cytometers are relatively expensive. In addition, flow cytometers can measure the presence of fluorescence labels and scattered light at rates of about 100,000 cells per second but can only sort cells from this stream at a rate of approximately 1,000 cells per second. However, most flow cytometers cannot associate specific cell characteristic(s) with any particular cell. For example, the flow cytometers can determine that a group of cells in a sample have a plurality of characteristics, but none of the specific characteristic values are associated with individual cells that were sorted into this group even though the characteristic values can be associated with subpopulations of the cells. In other words, direct association of sorted cells with their specific characteristics is lost in flow cytometers.

Another limitation is that most flow cytometers do not acquire images of the cells. There are some imaging flow cytometers, but these systems also have a number of limitations. For example, the fact that the systems image cells as they flow through the system means that there are significant challenges to acquiring relatively good images of the cells. In one such example, the imaging resolution of flow cytometers may be close to diffraction-limited but is affected by the variable focus positions of cells in the flow stream. In addition, there are no imaging flow cytometers on the market today that allow sorting as described above. In addition, if the cells could be sorted in such systems, individual cells are not tracked or associated with individual characteristic values.

Cytometry that does not involve cell flow during measurements also has a number of limitations. For example, tissue imaging may be performed on slides, but such imaging has relatively low throughput and the limited ability to sample, or perform follow up studies on, any of the cells. Imaging may also be performed using well-based cellular imaging. But these systems also provide limited capability for addressing or removing individual cells.

For general cell-based research, scientists gather data from a substantially large collection of cells (typically primary cells from an animal or human sample). They would prefer to analyze this data and classify the cells into subgroups based on multiple phenotypic readouts. They also wish to review some of these cells against the classifications or to generate finer distinctions within a class. They also wish to treat a subset of cells with new reagents to read out new phenotypes (even genotypes). In addition, they may wish to remove the cells for destructive analysis (e.g., sequencing) or to study behavior of a cell with other selected cells or in new environments. It is desired to keep cells viable during all the steps described above (e.g., by exchanging the culture medium). The embodiments described herein provide all of these capabilities (although any of the embodiments may be configured to provide fewer of these capabilities in any combination).

For CTC detection testing, it is desirable to perform minimal filtering or attempts to purify tumor cells after separating out the red blood cells (RBCs) and plasma. In addition, it is preferable for cell treatment, manipulation, and data collection to be performed in under one hour. It is also preferable for treatment and cell characteristic determination to be performed on a cell-by-cell basis with relatively high accuracy since currently molecular staining methods and cell size are the most reliable means to distinguish tumor cells. It is also desirable to review cells that are candidate tumor cells to verify they are tumor cells. It may even be desirable to re-stain (with different markers), image, remove, and test cells identified as candidate tumor cells. The embodiments described herein provide all of these capabilities for CTC testing and other cell-based testing (although any of the embodiments may be configured to provide fewer of these capabilities in any combination).

Accordingly, it is desirable to develop a high throughput cell imaging system that can analyze millions of cells. In addition, it is desirable for the cell suspension, staining, and preparation time to be roughly the same as that for flow cytometry (e.g., about 30 minutes). It is also desirable for the initial data collection (i.e., inspection or screening) timing to be roughly the same as flow cytometry (e.g., about 30 minutes). Furthermore, it is desirable to have the capability to collect multi-channel (color, bright field, backscatter) image data in the inspection or screening mode. It is also desirable to be able to perform statistical analysis of inspection or screening data as with flow cytometry. Review (re-imaging at higher resolution or 3D imaging) of selected cells or groups of cells is also desirable. In addition, refreshing the cells in between steps or even during image data acquisition (e.g., via culture medium exchange) is desirable. Furthermore, it is desirable to treat selected cells or groups of cells chemically (e.g., staining) in between steps and to be able to remove selected cells or groups of cells from the system or device for further testing or manipulation (such as single cell sequencing, cell-to-cell interaction studies, cell culture from individual cells, etc.). The embodiments described herein provide at least one or more of the capabilities described above and can be used for immobilizing, inspecting, reviewing, refreshing, retreating, and removing cells.

One embodiment relates to a device configured to immobilize cells for analysis. Each of the embodiments of the device described herein can be optimized or customized for different cell types (e.g., adherent, blood cells, etc.). In addition, each of the embodiments of the device described herein can be optimized for bio-relevant conditions. In general, the devices described herein are configured to allow cells to be imaged and tracked.

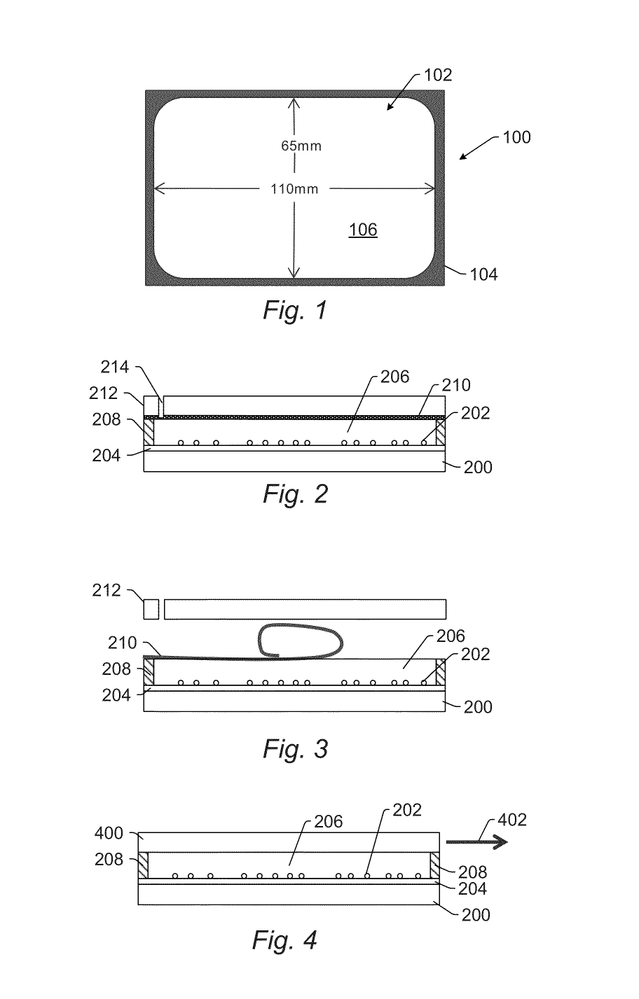

In one embodiment, the cells are not immobilized in individual containers within the device. For example, the device embodiments described herein may have full-field formats. However, the device embodiments may also have well-based formats. For example, the device may be configured as a disposable cell container with outer dimensions that are the same as a biotech industry standard 96 well micro-titer plate. In this manner, the device may have an external footprint equal to or commensurate with biotech industry standard micro-titer plates. Configuring the device to have such standard dimensions may be advantageous because many automation systems can accept this footprint and deliver fluids to different locations within the container. In one such embodiment, as shown in FIG. 1, device 100 may include container 102 formed by outer wall 104 and substrate 106 of the device. The container may have dimensions of approximately 65 mm by 110 nm. However, the device and the container may have any other suitable dimensions. The container may be a single, large field container as shown in FIG. 1, but can be segmented into 96 (8×12) regions (or another array say 4×6), for example, using the adhesion spots described further herein.

The cells may be labeled while in suspension. For example, the cells can be stained using antibodies conjugated to fluorescent or colored dye molecules or structures (e.g., quantum dots). Stains can label intracellular structures or molecules on cell surfaces or contained inside the cells. Energy transfer molecules can be used to label where fluorescence properties are dependent on proximity of two or more labeled biomolecules thereby discerning biochemical interactions. In addition, the cells can be suspended without using labels and imaging channels described herein can discriminate cells using innate fluorescence, color, or spectral scattering of the cells. The cells can also be suspended in a gel precursor solution for subsequent immobilization steps as described herein.

The device includes a substrate configured to support one or more materials configured to immobilize the cells within the device. The cells may be prepared on the substrate as described further herein. Preparing the cells on the substrate may also include arranging the cells on the substrate. For example, as shown in FIG. 2, the device may include substrate 200 configured to support one or more materials configured to immobilize cells 202 within the device. The substrate may be formed of any suitable material such as glass or another material that transmits light of an analysis system described herein without substantially altering properties of the light or, as in the case of optically flat glass, alters light paths in a deterministic way that can be compensated for in imaging optics (e.g., focus shift). For example, the substrate may be formed of a glass plate having a thickness of about 1 mm or any other suitable thickness. The glass cover may also have dimensions described above with respect to FIG. 1.

In one embodiment, the device includes a hard gel layer formed on the substrate under the one or more materials. For example, as shown in FIG. 2, the device may include hard gel layer 204 formed on substrate 200 under material(s) 206 configured to immobilize cells 202 within the device. The hard gel layer is preferably formed of a material that is inert to the one or more immobilization materials and is highly transmissive for the light of an analysis system described herein such that the hard gel layer does not substantially impact imaging of the light passing through the hard gel layer. The hard gel layer may have any suitable dimensions. For example, the hard gel layer may have a thickness of about 0.01 mm to 0.1 mm.

In one embodiment, the substrate is coupled to one or more additional structures configured to, with the substrate, contain a suspension of the cells and one or more pre-cursor materials, and the one or more pre-cursor materials include a polymer solution that forms a gel upon treatment to form the one or more materials that immobilize the cells within the device. For example, as shown in FIG. 2, the device may include additional structure(s) 208 coupled to substrate 200 (via hard gel layer 204 in the embodiment shown in FIG. 2; however, the additional structure(s) 208 may be coupled directly to the substrate with the hard gel layer or to the substrate itself formed inside the additional structures). The additional structure(s) may include any material in any configuration that can form outer walls of the device. The additional structure(s) may form a spacer or outer wall have any suitable dimensions. For example, the additional structures may have a height of about 0.5 mm. The additional structures can be used to contain liquid, contain the immobilization gel, or direct liquid over the cells.

A cell sample can be prepared as described above and then a polymer solution (gel precursor) can be added to the sample. The cells can be injected in a fixture designed to cover the interior of the device, or the cells can be spread over the substrate using spin coater-like devices such as those described in U.S. Patent Application Publication No. 2012/0069170 published Mar. 22, 2012 to Gesley, which is incorporated by reference as if fully set forth herein. The cells can then settle to the substrate surface and gel polymerization can be initiated. Gel formation can be initiated in any suitable manner (e.g., with ultraviolet (UV) or other light or by activating a catalyst that was added to the sample before addition of the sample to the device). The gel is preferably designed to allow carbon dioxide and nutrients to exchange while maintaining cell position during flow across the top of the gel as described further herein. The gel should also be designed to allow simple cell retrieval by either selective gel depolymerization thereby allowing cell aspiration or by gel coring using fine needles, both of which are described further herein.

In some embodiments, the device includes a spacer coupled to the substrate and forming an outer wall of the device, and the one or more materials are located within the outer wall. For example, additional structure(s) 208 shown in FIG. 2 may form an outer wall of the device, and one or more materials 206 are located within the outer wall formed by the additional structure(s). Other immobilization material(s) described herein may also be located within such an outer wall.

In another embodiment, the substrate is coupled to one or more additional structures configured to, with the substrate, receive an injection of a suspension of the cells and to substantially evenly disperse the cells within the device. For example, the substrate and the additional structure(s) shown in FIG. 2 may be configured to allow cell suspension injection and subsequent immobilization using a soft gel set. In one such example, a suspension of cells can be injected into the device (e.g., using fluid handling equipment described herein or manually by a syringe) and can settle on a hard gel layer described herein that was pre-coated on the substrate surface or an inert substrate surface (no hard gel layer) before a soft gel described herein sets and immobilizes the cells. In this manner, the device allows cells to be immobilized by initiating gelation of a cell suspension after loading the cells and allowing them to settle on the bottom of the device. As such, the device allows for cell suspensions to be easily injected and for the cells to be substantially evenly dispersed on the device bottom surface such that they are immobilized and ready for relatively high quality imaging.

In some embodiments, the device includes one or more removable structures positioned on a spacer coupled to the substrate, the spacer forms an outer wall of the device, and the one or more removable structures include a port through which a suspension containing the cells and the one or more materials is injected into the device. The material(s) may be exposed by removing the removable structure(s) to create a flow cell as described herein and/or to treat or remove cells. For example, as shown in FIG. 2, the one or more removable structures may include peelable tape 210 placed over additional structure(s) 208 (that form a spacer of the device coupled to substrate 200) and material(s) 206. The peelable tape may be formed of any suitable material and may have any suitable dimensions. The one or more removable structures may also include top cover 212 placed over the peelable tape. The top cover may be formed of any suitable material and may have any suitable dimensions.

The peelable tape and top cover may include port 214 through which a suspension containing the cells and the one or more materials can be injected into the device. For example, the port may be configured to couple to a fluid handling system such as that described further herein to receive the suspension. In addition, the port may be configured to couple to a syringe or other device that can be used to inject the suspension into the device manually.

As shown in FIG. 3, after the suspension of cells has been injected into the device and the one or more materials have been polymerized (or the cells have otherwise been immobilized in the device), top cover 212 may be removed from the device manually or automatically (e.g., via any suitable mechanical and/or robotic assembly). Peelable tape seal 210 can then be peeled off as shown in FIG. 3 manually or automatically (e.g., via any suitable mechanical and/or robotic assembly) thereby allowing access to the cells in the device (e.g., in the soft gel formed in the device), but without disturbing the gel and without significantly moving or disrupting the arrangement of the cells immobilized on the substrate.

Instead of a peelable tape, there are other options for exposing the one or more materials after the material(s) have immobilized the cells (e.g., after the soft gel has set between two rigid plates). In one such option shown in FIG. 4, the device may include top cover plate 400 formed over material(s) 206 and additional structure(s) 208. The top cover plate may be treated with Teflon or another inert chemical coating such that after cell immobilization the top cover plate can be slid off of the one or more materials as shown by arrow 402. In this manner, the top cover plate can be treated to be “non-sticky” and can be slid off carefully after the soft gel has set. The top cover plate may be formed of any suitable materials such as glass and may have any suitable dimensions.

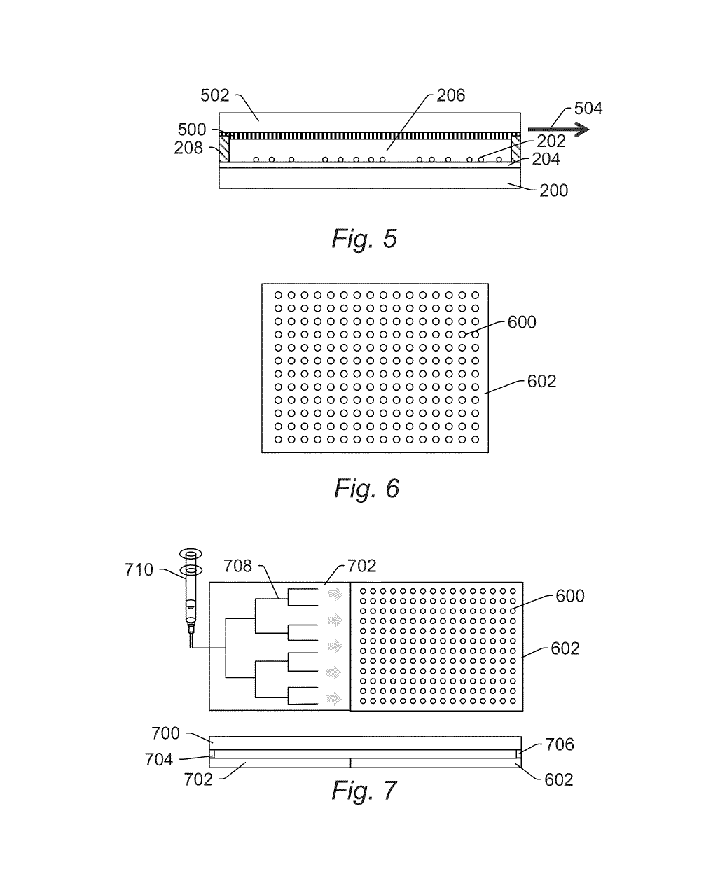

In another option shown in FIG. 5, the device may include thin mesh 500 formed over material(s) 206 and additional structure(s) 208 and top cover plate 502 formed over the thin mesh. In this manner, the mesh may be placed against the top cover plate while the one or more material(s) form the soft gel. The thin mesh may be positioned between the top cover plate and the one or more materials such that the gel stays intact when the top cover plate is removed (e.g., is slid off the thin mesh in the direction shown by arrow 504). In this manner, the top cover plate can be slid off carefully after the gel has set and the mesh will hold the gel together. The thin mesh may be formed of any suitable material and may have any suitable dimensions. The top cover plate may be formed of any suitable materials such as glass and may have any suitable dimensions.

In another embodiment, the one or more materials include a collection of cell adhesion spots formed on the substrate. For example, as shown in FIG. 6, the one or more materials may include adhesion spots 600 formed on substrate 602. In some embodiments, the one or more materials include a collection of cell adhesion spots substantially uniformly spaced from each other on the substrate. For example, as shown in FIG. 6, the cell adhesion spots may be formed on the substrate in a regular array (an array having uniform spacing between the spots). In this manner, the device allows cells to be immobilized by attaching cell adhesion molecules on the surface of the device in patches or spots that will lead to a relatively dense, isolated, uniform array of cells. However, the adhesion spots may be formed in any suitable arrangement on the substrate. Substrate 602 may be configured as described herein. For example, the substrate may include an optical quality glass plate. In some instances, the adhesion spots may be formed on the substrate by printing with a chemical printing pad, which can be formed by soft lithography.

The spots may have any suitable dimensions and spacings. For example, the spots may be configured to have a diameter of about 10 microns and may be spaced from each other by about 50 microns. If the spots have such dimensions and spacings and if the substrate has the dimensions described above (e.g., an active area of about 65 mm by about 110 mm or about 7,000 square millimeters), then the device could include about 2.9 million spots formed on the substrate. In this manner, in one embodiment, the device is configured to have more than 100,000 cells immobilized therein at any one time. For example, the devices described herein can hold more than 100,000 cells, more than 1 million cells, or even more than 10 million cells for one imaging run. (However, any suitable number of cell adhesion spots can be formed on the substrate.) The cell density in the device may then be about 20×20 or 400 cells per square millimeter. Adhesion molecules can be easily printed on a glass plate at this pitch and spot dimension using soft lithography and/or chemical printing methods as described by Whitesides et al., Science, Vol. 252, p. 1164, May 1991 or Whitesides et al., Science, Vol. 264, Apr. 29, 1994, which are incorporated by reference as if fully set forth herein.

In this manner, assuming that a cell is located at each cell adhesion spot, full device analysis by the systems and methods described herein allow screening of about 3 million cells in a single sample in a single device. In addition, for the diameter and spacing example described above and for full device imaging, the image area that would be useful for cell analysis would be about 4% (e.g., for a cell adhesion spot area of about 10 micron×10 micron divided by a spacing of about 50 micron×50 micron). Furthermore, if the cell adhesion spots are formed in a regular array on the substrate, the systems and methods described herein can use information about the array to determine when useful cell image data is being acquired during scanning of the device given the regular spacing of the spots.

In an embodiment, the device includes a fluid distribution device coupled to the substrate and including a plurality of flow channels through which a suspension of the cells is introduced to the device. For example, the cells can be spread throughout the device using a channeled fixture that guides the cells to adhesion spots where they can be attached to the substrate so that the cells are immobilized even during culture media re-flow. In addition, the fluid distribution device may include a temporary flow cell constructed to evenly arrange cells over adhesion spots so they might bind. In one such embodiment shown in FIG. 7, substrate 602 on which cell adhesion spots 600 are formed can be coupled to a fluid distribution device that includes two glass plates 700 and 702 and flow gaskets 704 and 706 that can be made of a material such as polydimethylsiloxane (PDMS). As further shown in FIG. 7, glass plate 702 may have a plurality of flow channels 708 formed thereon. The glass plate on which the flow channels are formed may be a PDMS flow channel piece made using soft lithography. Through one of the flow gaskets, the flow channels can be coupled to a fluid injection device which, although shown schematically in FIG. 7 as manually operable syringe 710, can be configured as a device that can be controlled by the computer subsystems described herein for automatic injection. In this manner, the fluid distribution device may be configured to inject a fluid or suspension containing the cells through the flow channels that distribute the fluid or suspension into a space formed over the cell adhesion spots on the substrate such that the cells can be “captured” by the cell adhesion spots. In this manner, the cell suspension may be injected into a fluid distribution device that will allow substantially even coverage of fluid flow (hence suspended cells) over the cell adhesion spots.

One or more additional steps may be performed to achieve substantially high and uniform cell density and to capture every cell in the sample suspension. For example, the cells may be agitated (e.g., stirred) before injection and may be made slightly negatively buoyant so that they will sink onto the adhesion spots as they travel across the surface of the substrate. In another example, the flow gaskets may define a relatively small capillary thickness (e.g., about 200 microns) above the substrate to minimize settling time. In addition, the flow rate may be slow enough to allow settling and adhesion but fast enough to move unattached cells to the next available adhesion spot. In an additional example, the effluent may be checked for cells that did not adhere. These cells may be run back through the flow cell, or the capture process may be modified to ensure 100% capture of the cells. In addition, the device may be examined after the injection of the cells to ensure that cells are only captured at array spots with only one cell per spot. Based on this analysis, the printing process or the injection process may be modified.

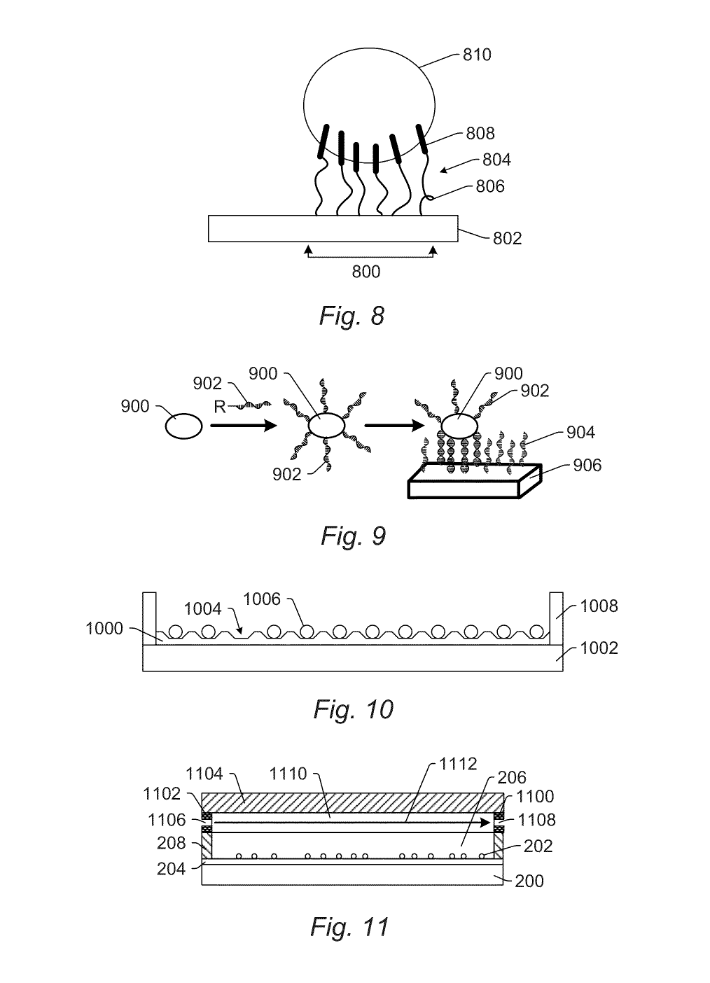

In some embodiments in which the one or more materials include a collection of cell adhesion spots formed on the substrate, the cell adhesion spots include molecules having a first part that binds the molecules to the substrate and a second part that tethers the cells to the molecules. For example, as shown in FIG. 8, adhesion spot 800 formed on substrate 802 includes a plurality of molecules 804 having first part 806 that binds the molecules to the substrate and second part 808 that tethers cell 810 to the molecules. The first part may be a hydrophilic part of a molecule that will orient it to a glass substrate. The reactive part of the molecule meant to irreversibly bind to the substrate could include a silane. The second part may be a hydrophobic part of the molecule that is meant to intercalate into a cell membrane. The molecules may also include generic hydrophobic tail molecules that bind to the substrate and tether cells as described in U.S. Patent Application Publication No. 2005/0106721 published May 19, 2005 to Nagamune et al., which is incorporated by reference as if fully set forth herein. An ortho-nitrobenzyl (photocleavable) group (e.g., Genome Res., 2005, 15: 1767-1776) can also be inserted into the hydrophilic part of the molecules that bind them to the substrate. In this case, the hydrophobic part of the molecules can be released along with the tethered cell when a given spot is selectively illuminated which breaks the ortho-nitro-benzyl bond.

In another embodiment, the cell adhesion spots include DNA-based linker molecules. For example, cells could be captured by cell adhesion spots that include commercialized DNA-based linker technology offered by Adheren, Emeryville, Calif. In one such example, as shown in FIG. 9, cell 900 can be exposed to a plurality of molecules 902 that link to the cells. The cells having a plurality of the molecules bound thereto may then be injected into the device as described further herein thereby bringing the cells into contact with linker molecules 904 attached to substrate 906. The molecules attached to the cells may then bind with the linker molecules attached to the substrate thereby adhering the cells in predefined spots on the substrate.

In an additional embodiment, the cell adhesion spots include adhesion molecules that bind to molecules found in or on membranes of the cells to attach any cell type. For example, the adhesion molecules may use azide chemistry to attach any eukaryotic cell type.

In a further embodiment, the cell adhesion spots include photo-labile capture molecules. For example, the photo-labile capture molecules may be configured as described in “Photolabile micropatterned surfaces for cell capture and release” by Sutcliffe and Revzin, Aug. 13, 2011, which is incorporated by reference as if fully set forth herein. In addition, the DNA-based linker technology available from Adheren may be combined with the approach described by Sutcliffe and Revzin. For example, the photolithographic chemical patterning described by Sutcliffe and Revzin may be used to pattern inert polyethylene glycol (PEG) around spots of carboxy-amines having diameters of about 10 microns and then coupling the photolabile linker with reactive amine groups at the ends. These molecules may then be reacted with a PEG polymer that reacts with the linker attached on one end and has a reactive imidazole group on the other end. The imidazole will bind to the membrane lipid molecules of any cell and will complete the tethering of the cell to each spot through many molecular linkages. The cell can then be released with selective UV exposure as described by Sutcliffe and Revzin.

In another embodiment, each of the cells are spaced from each other within the device. For example, in the case of a device that includes cell adhesion spots formed on a substrate, the cell adhesion spots can be printed in a predetermined array such that each of the cell adhesion spots are spaced from each other cell adhesion spot regardless of whether the spacing between the cell adhesion spots is uniform or not. In addition, each of the cell adhesion spots may be configured such that only one cell adheres to each spot. In this manner, the cells can be spaced from each other in the same manner as the cell adhesion spots. In the case of a device that includes material(s) such as a soft gel formed on a hard gel layer or a substrate, a number of steps may be taken to distribute the cells within the device such that they are spaced from each other. For example, the suspension of cells can be agitated just prior to being introduced into the device and after the suspension has been introduced into the device, the device itself can be moved rapidly to distribute the cells throughout the one or more materials. In one such example, if the cells are loaded at a density of about 400 cells per square millimeter and if the device has a full field area of 100 mm×65 mm as shown in FIG. 1, then for random spacing within the field, less than 10% of the cells should be closer than 1.5× the cell diameter from their nearest neighbors. In addition, less than 5% of the imaging area will contain cell pixels for such a device, thereby allowing for reduced image computing costs. Furthermore, scanning of an entirety of such a device by the methods and systems described herein allows screening of about 3 million cells.

The above described embodiments are advantageous because it is desirable to arrange and immobilize cells (e.g., all of the cells in a suspension sample and any cell type) in a substantially uniform manner just above the surface of the bottom (image quality) glass (or other transparent material) plate. It is also desirable to keep the cells separated from one another so that images of each cell can be discriminated and processed without confusion of pixels from one cell with pixels of another cell. It is further desirable to keep the cell area density relatively high (e.g., about one cell for every 50 micron×50 micron area or 2.5×10̂5 cells per cm̂2). Therefore, efforts are preferably made to space the cells by about 50 microns and to keep them from touching each other within the device. The cell adhesion spots described herein can accomplish this as long as every cell in the sample has an opportunity to pass over and bind to an adhesion spot and that once bound, the cell or the spot shields the binding molecules from binding another cell in that spot. In addition, there should be an excess of adhesion spots and the cells are preferably agitated or otherwise moved over the surface so as to pass over any available empty adhesion spot. If the cells are randomly settled to the bottom surface of the device as in the gel immobilization methods, then ultrasonic energy can be applied to the substrate in an effort for this vibration to cause the cells to move and repel one another and form a more even spacing than purely random locations. Any other methods to create substantially evenly spaced cells before the immobilization step may be used to prepare the device for analysis.

In some embodiments, the one or more materials include an optically clear plate having a regular array of depressions formed in the plate into which the cells in a suspension can settle with each of the cells in one of the depressions. In one such embodiment shown in FIG. 10, the one or more materials include optically clear plate 1000 formed on substrate 1002, which may be configured as described herein. The optically clear plate shown in FIG. 10 has a regular array of depressions 1004 formed in the plate into which cells 1006 can settle, with one cell in each of the depressions. The device may also include additional structures 1008 that can be configured as described above to, with the substrate, contain the suspension of cells. For example, the cells can be arranged on the substrate by spreading or flowing the cells over micro-wells where the cells are kept contained even with media solution reflow (e.g., Langmuir, 2003, 19, 9855-9862, which is incorporated by reference as if fully set forth herein). The optically clear plate can be etched or otherwise machined (e.g., via laser ablation) such that depressions having a diameter of about 10 microns can be formed in the plate in a roughly 50 micron pitch array. In this case, ultrasonic energy can be applied to the substrate as described above to allow the cells to move and assume the lowest energy configurations, which would be every cell occupying a “lower” depression location.

The device also includes features configured for use by an analysis system for separately determining and tracking positions of each of the cells in the device on a cell-by-cell basis. For example, the substrate may contain landmark structures (say, posts in an array with a 1 mm pitch) that will allow easy cell re-location in any number of imaging systems (e.g., for imaging, analysis, retrieval, etc.) described herein. A cell location can be described by x, y offsets for a given landmark that can be viewed in the same image as the cell (if the image extends to 1 mm or greater as is typical for many high resolution microscopes). In this manner, the features can be used to reproducibly identify the location of any given cell within the device and therefore can be used to determine reproducible locations of the cells that can be used for tracking of individual cells and re-imaging of each cell. For example, the positions of the cells in the device can be used to separately re-image each of the cells in the device.

In some embodiments, the device is fabricated with mechanical features located on regions on the perimeter of the device that allow for fast but extremely accurate re-positioning of the device within a coordinate system known to the imaging system. This is sometimes referred to as kinematic mounting and could be used to re-locate cells between multiple systems with highly accurate internal positioning capabilities as long as one part of the device is located and oriented in a well-defined way with respect to the imaging system mechanical layout.

In some embodiments, the features may be configured as shown in FIG. 6 except that each adhesion spot 600 can be replaced with a post as described above. In this manner, the features may be configured in an array across the substrate as shown in FIG. 6 although possibly with different dimensions and spacings than that described with respect to the cell adhesion spots. For example, it may not be necessary to have a post or other feature for every cell or every cell adhesion spot. In other embodiments, the features may include alphanumeric characters or symbols etched into the substrate. In addition, the features may include markings such as thin lines etched into the substrate and forming some sort of grid across the substrate. In short, any feature that can be incorporated into the devices described herein in a manner such that the positions of the cells can be tracked over time using the features would be suitable for use in the embodiments described herein.

In one embodiment, information for the positions of the cells within the device is recorded and maintained by the analysis system. For example, the analysis system may use the features of the device to track individual cell locations within the device and image data associated with each cell. The analysis system may be configured to record and maintain information for the cell positions as described further herein.

The substrate and the one or more materials are configured to not optically interfere with light focused to the cells and the features by the analysis system and light from the cells and the features detected by the analysis system. Not optically interfering with the light may include altering the light in some negligible and predictable manner that can be compensated for in the systems and methods described herein. For example, as described above, the substrate may include an “optically clear” glass plate. The one or more immobilization materials also preferably do not substantially alter any properties of the light (or whose change can be easily compensated) used for illumination and detection by the analysis system. For example, the materials of the device preferably have substantially high transmission for wavelengths of light used by the analysis system and preferably do not substantially scatter or refract the wavelengths of light. In addition, the materials of the device preferably do not alter the polarization of the light used by the analysis system. Furthermore, if the materials of the device do alter the light used by the analysis system in some manner, as long as the manner in and degree to which the light is altered is relatively insignificant and predictable, the materials and the device will most likely not interfere with the imaging capabilities of the analysis system.

In this manner, in one embodiment, the substrate and the one or more materials are configured to allow substantially high resolution imaging of the cells within the device. In particular, the one or more materials are preferably configured to immobilize the cells in a manner suitable for relatively high resolution imaging.

The device also includes one or more structures configured to couple an environmental control subsystem to the device. The environmental control subsystem is configured to control an environment of the cells within the device while the device is positioned in the analysis system without altering the positions of the cells within the device. In this manner, the device can be placed in an imaging system and attached to an environmental control subsystem. The environmental control subsystem may be configured to alter or maintain any physical, chemical, or biological properties of the cells and any materials surrounding the cells. For example, the environmental control subsystem may be configured to alter one or more chemical, fluid, or material properties, temperature, pressure, etc. of the environment surrounding the cells. In one such example, the environmental control subsystem may control the temperature (e.g., to maintain a temperature of about 37 degrees C.) and the carbon dioxide partial pressure around the cells.

In one embodiment, the environmental control subsystem is configured to control the environment by altering or maintaining one or more characteristics of a fluid environment of the cells. For example, the environmental control subsystem may be configured to flow media across the cells while in an imaging platform. In one such example, the liquid inside a soft gel described herein can be refreshed using flowing medium during or after screening runs. In addition, the environmental control subsystem may be configured to replace the fluid surrounding the cells (e.g., by pumping cell culture media into the device). In this manner, the environmental control subsystem may be configured to refresh or exchange the fluid environment of the cells without losing the cell location tracking.

In some embodiments, the one or more structures include a flow cell gasket placed above the one or more materials in which the cells are immobilized. For example, as shown in FIG. 11, the one or more structures may include flow cell gasket 1100 that may include spacers 1102 coupled to top cover 1104. Ports 1106 and 1108 are formed in spacers 1102 such that when the spacers are coupled to additional structures 208 as shown in FIG. 11, a flow cell is formed in the device above the material(s). Flowing media 1110 can be directed through the device across material(s) 206 (e.g., in direction 1112 if port 1106 is used as the in-port and port 1108 is used as the out-port) by coupling a fluid handling subsystem to the ports.

In another embodiment, the one or more structures include a flow cell constructed over the cells prior to, during, or after imaging of the cells, and the environmental control subsystem is configured to couple to and operate the flow cell prior to, during, or after the imaging of the cells. In this manner, the device allows for construction and operation of a flow cell over the top of the cells prior to, during, or after cell imaging. In an additional embodiment, the flow cell is constructed using replaceable gaskets. For example, the flow cell may be constructed over the cells using a flow cell gasket such as that described above. The environmental control subsystem may include a fluid handling subsystem that is coupled to and operates the flow cell as described above. The fluid handling subsystem may be further configured as described herein.

In some embodiments, the flow cell is a thin layer of fluid. In another embodiment, the flow cell is a thin layer of fluid having laminar flow characteristics. For example, the flow cell may be a thin (less than 1 mm) layer of fluid and could be laminar flow. The flow cell thickness and flow characteristics may be selected and controlled by designing the flow cell gaskets described herein and controlling the fluid handling subsystem that provides the fluid to or pumps the fluid through the flow cell.

In a further embodiment, the flow cell is constructed by removing a portion of the device to expose the one or more materials. For example, a gel can be exposed and the flow cell created by peeling off a tape, sliding off a “non-stick” cover glass, or containing the gel in a mesh. In this manner, after the materials in the device are exposed (e.g., by removing the peelable tape), a flow cell gasket can be placed above the soft gel to create the flow cell that can be used to allow media to refresh cells in the soft gel.

The devices described herein are designed to allow substantially precise and relatively fast removal of selected cells. For example, as described above, the device may include a hard gel layer formed on the substrate under the one or more materials. In one such embodiment, the one or more materials include a soft gel, and portions of the soft gel and the hard gel layer are removed by coring during cell removal from the device. For example, the device may include an optical quality hard gel layer formed on top of the substrate and the cells may rest on the hard gel layer. In this manner, both the hard gel layer and the soft gel can be cored during cell removal. Coring may be performed using methods and systems described further herein.

In another embodiment, the one or more materials include a photo-depolymerizable gel. For example, the immobilization material(s) may include a biocompatible, optically clear gel that can immobilize cells and allow imaging and fluid exchange during inspection and review, but also can be reversed to a solution upon selective exposure to light levels that are “safe” for the cells. Such a gel can be used to eliminate the hard gel layer on the substrate since, rather than coring a plug of the hard gel layer and the soft gel for cell removal, the gel can be depolymerized in a volume (e.g., a cylindrical volume) just above the cell selected for removal and simple liquid aspiration can remove only that cell and not cells that are under the fully polymerized soft gel. In this manner, the light beam is the only element that must be positioned and narrowed to dimensions on the order of 10 um to 50 um, and the aspiration device can be positioned more coarsely and be substantially physically larger than these dimensions. In some instances, the soft gel may be an alginate gel that can be photo-dissolved. Selective photo-depolymerization of the soft gel or other immobilization materials may be performed using methods and systems described further herein.

In an additional embodiment, the one or more materials release the cells immobilized therein upon exposure to a predetermined wavelength of light. For example, the adhesion molecules described herein may be configured such that they can be cleaved or cut so as to release a cell at a later time. The release of the cells from such immobilization material(s) may be performed using methods and systems described further herein.

Each of the embodiments of the device described above may be configured according to any other device embodiments described herein. In addition, each of the embodiments of the device described above may used by any of the system and method embodiments described herein.

Another embodiment relates to a system configured to determine information for cells. As described further herein, the system allows cells to be imaged and tracked.

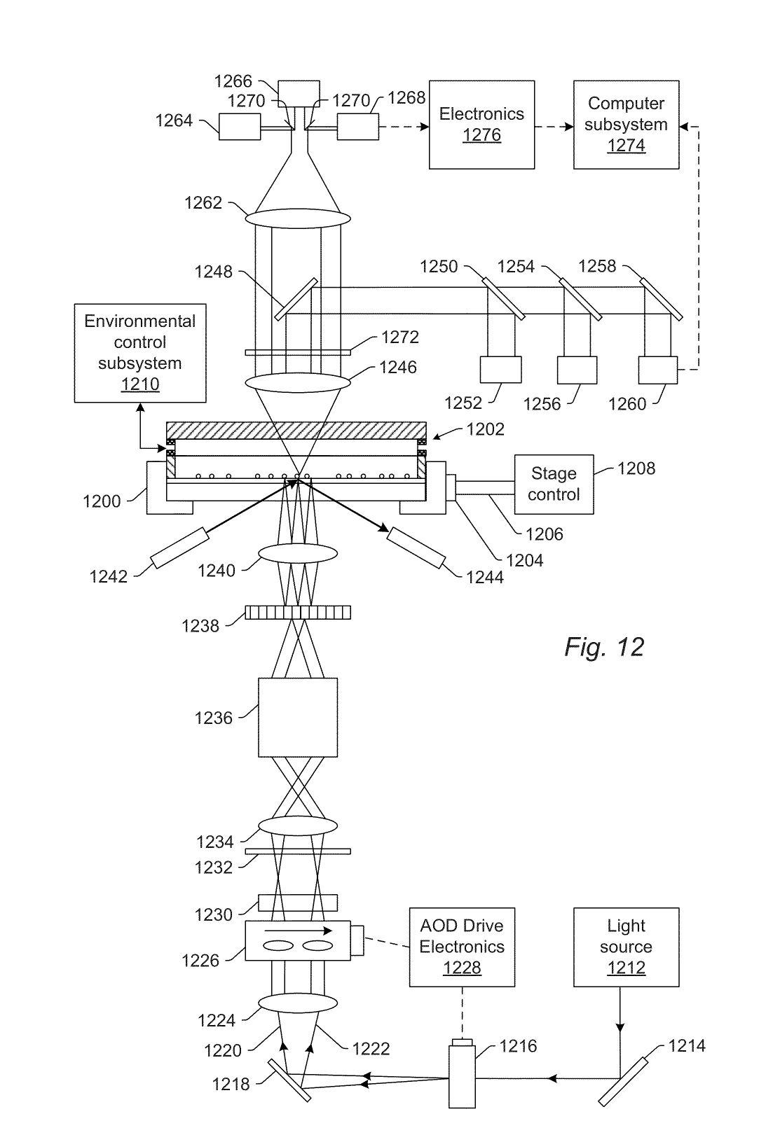

The system includes an environmental control subsystem configured to control an environment of cells immobilized in a device while the device is positioned in the system without altering positions of the cells within the device. For example, the environmental control subsystem can refresh or exchange the fluid environment of the cells without losing cell location tracking. In one example, as shown in the system of FIG. 12, the system may include environmental control subsystem 1210 configured to control an environment of cells immobilized in device 1202 while the device is positioned in the system. The environmental control subsystem may be configured as described further herein. In one embodiment, the environmental control subsystem is configured to maintain viability of the cells while the device is positioned in the system by controlling the environment of the cells within the device before, during, and after the detection subsystem described herein generates the output as described further herein. In this manner, the embodiments described herein support live cell screening. In addition, the device can be removed from the system and stored in another environmental controlling subsystem (not shown) and then replaced in the system when imaging data or other output described herein is to be acquired or generated.

The device that immobilizes the cells for analysis by the system may be further configured as described herein. For example, the device has features used by the system for separately determining and tracking positions of each of the cells in the device on a cell-by-cell basis. In addition, the device immobilizes the cells in a manner suitable for relatively high resolution imaging.

In one embodiment, the system includes a stage configured to support the device within the system and to maintain a predetermined and fixed position of the device on the support, optionally using kinematic mount features described herein. For example, as shown in FIG. 12, the system may include stage 1200 configured to support device 1202, which may be configured as described and shown in FIG. 11 or any of the other figures described herein, within the system. The stage may be configured to contact and support only the portion of the device nearest the outer edge(s) of the device such that if the system is configured to detect light transmitted by the cells, the stage does not interfere with the functioning of the system.

As shown in FIG. 12, the stage may contact the outer portion of the bottom surface of the device as well as the outer side surfaces of the device. The stage may be configured to contact the device in this manner such that by positioning the device flush against multiple surfaces of the stage, the device can be positioned in a predetermined position within the stage and therefore within the system. In this manner, the device can be removed and replaced with substantially accurate re-location. However, the stage may be configured in any other manner to position the device substantially accurately in a predetermined location on or within the stage.

As shown in FIG. 12, the stage may be coupled to mechanical elements 1204 and 1206 that together with stage control subsystem 1208 can cause the stage to move in 3 dimensions (x, y, and z) within the system. In this manner, the stage can move the device laterally and vertically within the system (e.g., for scanning and for focusing). Mechanical elements 1204 and 1206 and stage control subsystem 1208 may include any suitable mechanical and/or robotic assembly known in the art.

The system also includes an illumination subsystem configured to focus light to the cells immobilized in the device and the features. In general, the illumination subsystem may include one or more light sources configured to generate light and one or more optical elements configured to direct the light to the cells in the device. For example, in the embodiment shown in FIG. 12, the illumination subsystem includes light source 1212 configured to generate light. The light source may include a variety of light sources depending on, for example, the application for which the system is to be used. For example, in one embodiment, the illumination subsystem includes a laser sustained plasma light source (LSPLS) configured to generate the light that is focused to the cells. In another embodiment, the illumination subsystem includes an arc lamp. In an additional embodiment, the illumination subsystem includes a pulsed laser. In addition, the light source may include a continuous wave (CW) light source that is nominally single wavelength (laser or laser diode). The light source may also generate light having one or more wavelengths between about 350 nm and 450 nm. The illumination subsystem may also include multiple light sources and the system could select between light sources (and possibly other optical elements used for different light sources), for example, if the wavelength setting of the illumination subsystem is changed by a user.

In some embodiments, the illumination subsystem includes an acousto-optical device (AOD) configured to scan the light over the cells while the detection subsystem described further herein generates output for the cells. For example, in the embodiment shown in FIG. 12, light from light source 1212 is directed by folding mirror 1214 to AOD prescanning optics 1216. Light from the AOD prescanning optics may be directed to folding mirror 1218. The prescanning optics are configured to deflect the light beam from the light source across a distance from a start of a scan shown by light beam 1220 to an end of the scan shown by light beam 1222. Folding mirror 1218 directs the light from the AOD prescanning optics to lens 1224, which may be a travelling lens that directs the light to chirp AOD 1226. AOD drive electronics 1228 may be coupled to AOD prescanning optics 1216 and chirp AOD 1226 and may be configured to control the functioning of both elements. The illumination subsystem may also include lens 1230, which may be a cross axis (perpendicular) cylinder lens.

In some embodiments, the illumination subsystem is configured to focus the light to more than 100,000 of the cells immobilized in the device in a single run by scanning the light over the cells. For example, the AOD described above and shown in FIG. 12 allows the light from the light source to be scanned over the cells in the device substantially quickly. In this manner, the illumination subsystem may scan the light over a substantial number of cells in a single run or test.

Lens 1230 may be configured to direct the light from the chirp AOD through optional optical element 1232 to lens 1234. Optional optical element 1232 is shown as a single optical element in FIG. 12 for the sake of simplicity. However, this element may actually include one or more optical elements configured to alter one or more characteristics of the light from the light source. For example, in another embodiment, the illumination subsystem is configured to alter one or more characteristics of the light focused to the cells, and the one or more characteristics include one or more wavelengths of the light, one or more polarizations of the light, a shape of the light focused to the cells, one or more illumination angles, or a combination thereof. In such embodiments, optional optical element 1232 may include a number of optical elements such as spectral filters, polarizing components, beam shaping elements, and the like configured to alter one or more characteristics of the light from the light source before the light is focused to the cells. These optical elements may be arranged in a number of positions within the illumination subsystem and along the beam path of the illumination light depending on the actual configuration of the illumination subsystem. Therefore, the position of optional optical element 1232 shown in FIG. 12 is meant to be merely illustrative and may vary depending on a number of factors.

Lens 1234, which may include any suitable refractive lens known in the art, may be configured to direct the light from cross axis cylinder lens 1230 or optional optical element 1232 to lens 1236, which may be a magnification converter (a telescopic lens). The illumination subsystem may be configured such that light from lens 1236 is directed to diffractive optical element (DOE) 1238 or objective 1240. For example, in one embodiment, the illumination subsystem is configured to focus the light to the cells by focusing multiple spots of light to the cells simultaneously. Therefore, the illumination subsystem may include a DOE such as DOE 1238 that is configured to generate multiple light beams from a single light beam. The illumination subsystem may be configured to then focus the multiple light beams to multiple spots proximate the cells in the device. For example, in the embodiment shown in FIG. 12, objective 1240 is configured to focus the light beams to multiple spots of light proximate the cells simultaneously. In this manner, the systems described herein may be configured for simultaneous multi-spot illumination. The objective may be a near band objective or a broadband objective. The objective may also have a field of view (FOV) from about 0.2 mm to about 2 mm and a numerical aperture (NA) from about 0.2 to 0.9. Although the system is shown in FIG. 12 with 3 light beams generated by the DOE and directed to the cells by the objective, the illumination subsystem may be configured to generate and focus any suitable number of light spots to the cells simultaneously.

In another embodiment, the illumination subsystem is configured to focus the light to the cells by focusing a single spot of light to the cells. For example, if the illumination subsystem shown in FIG. 12 is modified by removing DOE 1238, the illumination subsystem would be configured to focus a single spot of light to the cells.

The system further includes a detection subsystem configured to generate output responsive to light from the cells and the features. The output may include images of the cells (e.g., for screening), image data, other data, signals, and any other output that can be generated by the detectors described herein or any other detectors that may be included in the detection subsystem.

In some embodiments in which the illumination subsystem includes a CW laser or laser diode (preferred for spot scanning systems), LSPLS, are lamp, pulsed laser, or other light source configured to generate the light, the system includes a stage (e.g., stage 1200) configured to support and move the device (e.g., device 1202), and the stage and a detector of the detection subsystem are synchronized for movement and imaging of the cells within the device. For example, regardless of the light source, the stage and the any of the detectors described herein can be synchronized so that the entire area of the device is imaged in the shortest time possible.

In another embodiment, the illumination subsystem is configured to scan the light over the cells while the detection subsystem generates the output, and the output is generated for more than 1 million cells in less than 10 minutes. In this manner, the system may be configured for substantially fast imaging of an entire cell sample (e.g., in tens of minutes). In addition, the embodiments can be used to screen about 1 million cells per minute. The images can be obtained by scanning one or more focused spots of excitation light as described herein and continuously collecting emitted fluorescence, transmitted light, or scattered light. For example, in one embodiment, the system includes a scanning subsystem (e.g., stage 1200) configured to move the device while the illumination subsystem focuses the light to the cells (during which the AOD and other optics may sweep the illumination spot perpendicular to the stage motion), and the detection subsystem generates the output, and the output is generated for more than 1 million cells in less than 10 minutes.

In some embodiments, the device immobilizes millions of the cells, and the illumination and detection subsystems are configured such that the light can be focused to any of the millions of cells and such that the output can be generated for any of the millions of cells. For example, the illumination subsystem may be configured to direct the light to any of the millions of cells by deflecting the illumination light with an AOD or another light deflection element and the detection subsystem may be configured to detect light from any of the positions in the device illuminated by the illumination subsystem. In another example, the stage described herein may be configured to move the device such that any cell in the device can be illuminated and imaged.

In one embodiment, the illumination subsystem is configured to scan the light over the cells while the detection subsystem generates the output, and the light is scanned at a rate faster than 1 millisecond per 1 mm sweep. For example, the system may use raster spot scanning at the shortest illumination wavelength (for best resolution) and the spots may be rastered at a rate faster than 1 millisecond per 1 mm sweep or even 100 microseconds per 1 mm sweep. Such sweeps may be performed using an AOD as described further herein. In addition, more than one spot may be rastered simultaneously for higher throughput.

In some embodiments, the system includes an auto-focus subsystem configured to monitor and adjust a position of the cells with respect to a focal plane of the system while the output is generated by the detection subsystem. For example, the system shown in FIG. 12 includes an auto-focus subsystem that includes light source 1242 configured to direct light to an image plane of the system and detector 1244 configured to detect light reflected from the image plane. The detector may be coupled to the computer subsystem described further herein and output generated by the detector may be used by the computer subsystem to determine a position of the device with respect to the image plane of the system. The computer subsystem may be configured to determine if the position of the device with respect to the image plane needs to be adjusted based on that output and may be configured to provide instructions to stage control 1208 to move the device accordingly. In this manner, the system can be configured for relatively fast, real time auto-focus that allows mechanical tracking of the sample height versus image focal plane so that cell images are consistently acquired in the entire imaging run.

The system may also be configured for Z-slice selection of +/−2 microns. For example, faster screening times may allow multiple screens or scans at different focus offsets (say 6 scans with a 1.5 micron focal plane step between each scan). The computer subsystem may also use output generated by the detector of the auto-focus subsystem to move the device to different positions along the z axis of the system so that the detection subsystem can generate different output at different heights within the device. In this manner, the system may be configured to generate 3D representations of cells.

In another embodiment, the detection subsystem includes multiple channels configured to detect the light from the cells and the features simultaneously, and the output includes different output generated by the multiple channels. In this manner, the output used by the computer subsystem as described further herein to determine characteristic(s) of the cells may include output generated by multiple channels. In one such embodiment shown in FIG. 12, the detection subsystem includes collection optics 1246, which may be 20×, non-imaging optics having an NA of about 0.9. The collection optics can be used to direct the light from the cells to one or more channels that each may include a detector and one or more optical elements coupled to the detector as described further herein.

In a further embodiment, the detection subsystem includes a pupil splitter configured to direct a portion of the light from the cells to one or more channels configured to detect fluorescence emitted by the cells and another portion of the light from the cells to one or more channels configured to detect light scattered by or transmitted through the cells. For example, as shown in FIG. 12, the detection subsystem may include pupil splitter 1248 configured to reflect the light from the device in one portion of the NA of the collection optics to one or more channels and to allow the light from the device in another portion of the NA of the collection optics to pass to one or more other channels. The pupil splitter may also include one of multiple pupil splitters that include different, optional apertures (e.g., for the light that is directed to the elastic scattering channel(s)). In addition, the pupil splitter shown in FIG. 12 may be replaced with an optical element that is configured to split the entire NA of the collection optics into two different paths. For example, the pupil splitter shown in FIG. 12 may be replaced with a dichroic beam splitter for optional full sky pupil imaging for the fluorescent and/or elastic scattering or BF channels described herein.

In a further embodiment, the detection subsystem includes multiple channels configured to detect the light from the cells simultaneously, and the multiple channels include two or more channels configured to detect fluorescence emitted by the cells. In an additional embodiment, the detection subsystem includes multiple channels configured to detect the light from the cells and the features simultaneously, and the multiple channels include two or more channels configured to detect fluorescence emitted from the cells and one or more channels configured to detect light specularly reflected from, scattered by, or transmitted through the cells. For example, the detection subsystem may be configured for 3 channel fluorescence scattering detection and for bright field (BF) image capture. The BF and fluorescence images may be captured with relatively high resolution (e.g., about 0.8 micron resolution).

In the embodiment shown in FIG. 12, the light reflected by the pupil splitter may be directed to 3 channels configured to detect fluorescence emitted by the cells. For example, the light reflected by pupil splitter 1248 is directed to dichroic beam splitter 1250 that is configured to pass light having wavelengths longer than a first wavelength and to reflect light having wavelengths shorter than the first wavelength to detector 1252. Light transmitted by dichroic beam splitter 1250 is directed to dichroic beam splitter 1254 that is configured to pass light having wavelengths longer than a second wavelength and to reflect light having wavelengths shorter than the second wavelength to detector 1256. Light transmitted by dichroic beam splitter 1254 is directed to dichroic beam splitter 1258 that is configured to reflect light having wavelengths shorter than a third wavelength to detector 1260. Beam splitter 1258 may also transmit light having wavelengths longer than the third wavelength (e.g., if the detection subsystem includes additional fluorescence channels) or the beam splitter may be replaced with a reflective mirror configured to direct all of the light transmitted by dichroic beam splitter 1254 to detector 1260.

In this manner, light in different wavelength ranges (e.g., shorter than a first wavelength, longer than the first wavelength and shorter than a second wavelength, and longer than the second wavelength) may be detected separately by the detection subsystem. The different wavelength ranges may be selected based on the cell samples that will be analyzed by the system and by the fluorescent molecules used to mark these cells. In addition, one or more of the wavelength ranges may be altered (e.g., by changing out one or more of the dichroic beam splitters) based on any cells that are being analyzed. The detectors of the fluorescent channels (e.g., detectors 1252, 1256, and 1260) may include any suitable detectors and in some instances may include imaging detectors. In some embodiments, the portion of the collection pupil that is directed by the pupil splitter to the fluorescent channels may be less than 0.5 NA.

The portion of the collection NA that is not reflected by the pupil splitter may be light in the high NA (0.5-0.9 NA) portions of the collection optics. In this manner, the light that is not directed to the fluorescent channels may be directed to an elastic scattering channel. For example, as shown in FIG. 12, the light that is not directed to the fluorescent channels by the pupil splitter can be directed by lens 1262 to one or more other detectors (e.g., detectors 1264, 1266, and 1268). Detectors 1264, 1266, and 1268 may include any suitable detectors such as photomultiplier tubes (PMTs).

In another embodiment, the illumination subsystem is configured to focus the light to the cells by focusing multiple spots of light to the cells simultaneously, and the detection subsystem includes an image plane splitter configured to separate the light from the multiple spots into separate beams that are directed to different detectors. For example, in the embodiment shown in FIG. 12 in which 3 different spots of light are shown being focused to the cells simultaneously, the detection subsystem includes image plane splitter 1270 configured to direct light from each of the different spots of light to one of the detectors. In this manner, light from each spot may be directed to only its corresponding detector such that the light from each spot can be separately detected. The image plane splitter may include any suitable reflective or partially reflective element(s).

In another embodiment, the detection subsystem includes one or more polarizing components configured to alter one or more polarizations of the light from the cells. For example, in the embodiment shown in FIG. 12, the detection subsystem includes polarizing component 1272 configured to alter one or more polarizations of the light from the cells. The polarizing component may include any suitable polarizing component known in the art and one or more characteristics of the polarizing component may be altered depending on the polarization(s) desired to be detected by the detection subsystem. In addition, the system may be configured to replace or remove the polarizing component depending on the cells or the cell analysis being performed by the system. The polarizing component may also be positioned in any other suitable location in the detection subsystem. Furthermore, the detection subsystem may include multiple polarizing components arranged in different positions in the detection subsystem. For instance, the detection subsystem may include one polarizing component in the path of the light detected by only one channel and another polarizing component positioned in the path of the light detected by only another channel of the detection subsystem.

In some embodiments, the detection subsystem includes one or more detectors configured to generate the output at a rate faster than 100 million output data samples per second. For example, the image collection channels described herein may operate at above 100 million pixels per second or even 1 billion pixels per second. In one embodiment, the output includes image data, and the detection subsystem includes one or more PMTs configured to operate at more than 100 million output data samples per second. For example, PMTs may be used to collect image data from rastered spots and these can operate at more than 100 million samples per second.

The system also includes a computer subsystem configured to correlate the cells individually with their positions within the device based on the output responsive to the light from the cells and the features and to determine one or more characteristics of the cells based on the output responsive to the light from the cells. For example, in the embodiment shown in FIG. 12, the system includes computer subsystem 1274, which may be coupled to any detectors of the detection subsystem by one or more transmission media shown in FIG. 12 by the dashed lines, which may include “wired” and/or “wireless” transmission media, such that the computer subsystem can receive output generated by the detectors of the detection subsystem.

Computer subsystem 1274 may take various forms, including a personal computer system, mainframe computer system, workstation, image computer, parallel processor, or any other device known in the art. In general, the term “computer subsystem” may be broadly defined to encompass any device having one or more processors, which executes instructions from a memory medium.

The computer subsystem may also be coupled to one or more of the detectors by electronics such as electronics 1276 that receive output from detectors 1264, 1266, and 1268 and transmit that output to computer subsystem 1274. Electronics 1276 may include PMT electronics such as a 300 MHz analog-to-digital (A2D) convertor for each PMT. The output of the detectors may include, for example, signals, images, data, image data, and the like. The computer subsystem may be further configured as described herein. The information may include one or more of data, image data, images, and any other form in which the information described herein can be output. The information may be stored in or output as an inspection results file.

The output (e.g., images) generated for and associated with each cell at each location can be identified. In this manner, the computer subsystem can track cell locations and image data associated with each cell. For example, the image channel data described above may be first analyzed so that cell boundaries can be identified and pixels associated with individual cells can be grouped. Identifying the pixels corresponding to individual cells can be performed using threshold analysis of image data and creating a binary image (cell material present/not present). The binary pixels are grouped using topological image analysis tools so that a given cell is shown as a localized collection of pixels used in further cell analysis. A centroid or other repeatable location within each cell can be identified and used as the location for each cell. These locations can be relative to some global landmark (e.g., the corner of the substrate) or using the other features of the device described further herein. Cells and their locations and properties of their image data can be placed into a large database with cell ID (arbitrary cell counter) and location as a “key field” that uniquely identifies each cell (out of possibly millions).

The computer subsystem may determine the characteristic(s) of the cells in a number of different manners. For example, the computer subsystem may analyze screening output or data for the cells by creating image based “characteristics” associated with each cell at each location. In one such example, after each cell is identified and the pixels for that cell are identified, the computer subsystem can create cell image characteristics. Characteristics can involve morphological properties of any given image channel. For example, the length of the boundary of a thresholded cell image can be considered a characteristic, or the area of the cell or properties of structures inside the cell determined by image manipulation for that cell can be considered a characteristic. Characteristics can be associated with relative strength or weakness of image intensity in each channel. For example, one color can correspond to the presence of a molecular label. The computer subsystem may also combine morphology and molecular identity as a characteristic.

If the system includes more than one channel as described above, the computer subsystem can use the output generated by only one channel or more than one channel, in combination, to determine the characteristic(s) of any one or more of the cells. In this manner, the computer subsystem may use multiple image “channel data.” For example, whether discrete band pass filters are used or entire spectra are collected at each pixel as described herein, the computer subsystem may construct image data that corresponds to different channels of data. In one such example, images can be reconstructed so that each discrete fluorescent probe is isolated and represented on a separate image. If excitation and emission wavelengths are varied, then images can be constructed by specific combinations of excitation and emission wavelengths. The detailed excitation and emission wavelength data at each pixel can be used to discern molecular or cellular “fingerprints” of features in the cell that come from innate fluorescence or specific absorption or scattering mechanisms that allow identification of molecules and subcellular structures without the use of labels.

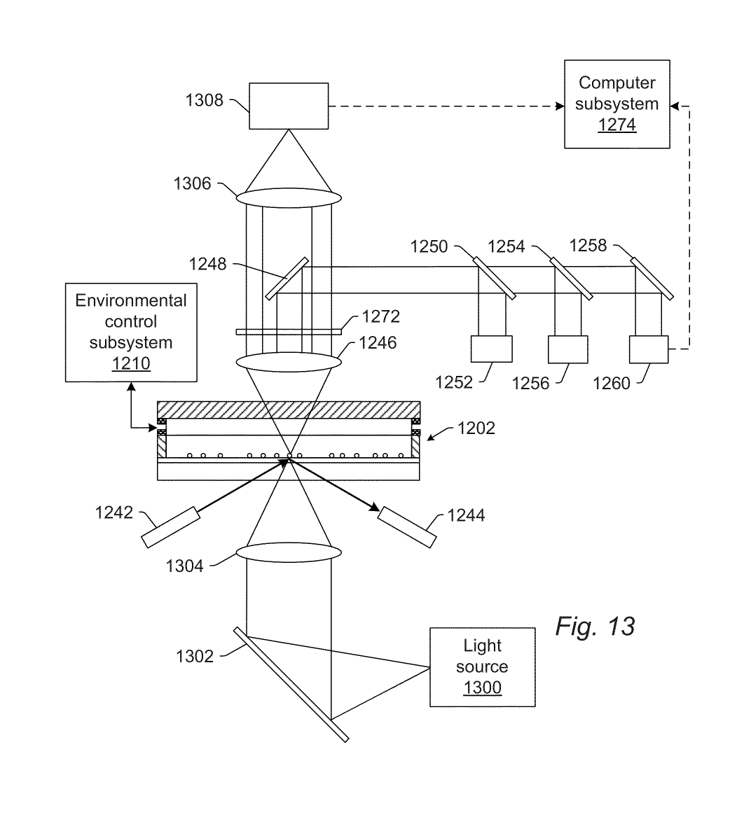

In some embodiments, the illumination subsystem is configured to focus the light to the cells by line illumination. In another embodiment, the illumination subsystem is configured to focus the light to the cells by flood illumination. In this manner, the system may be configured for 2D flood imaging or ID line imaging. One embodiment of such a system is shown in FIG. 13. The illumination subsystem of this embodiment includes light source 1300 that may be a CW or pulsed light source. The light source may also include an arc plasma lamp, an LSPLS, a super-continuum laser diode, multiple discrete lasers, or some combination thereof. The light source may also be a broadband light source (e.g., a plasma lamp) and different illumination bands (e.g., from 360 nm to 600 nm) may be selected for illumination using band pass color filters (not shown) that may be positioned in the path of the light from the light source. Alternatively, the illumination subsystem may include multiple lasers or laser diodes that can be switched in and out as long as the illumination optics are configured for broadband illumination. In general, CW light is good for the spot illumination described herein, and pulsed light can work for line imaging but with about a 1 MHz pulse rate and for flood illumination with down to 1 KHz pulse rates. All illumination schemes described herein can work with CW light. Also, spot illumination may be performed with laser light because the relatively low etendue of the light allows substantially tight focusing of the light without loss of power.

Light from the light source may be directed to reflective optical element 1302 that may be a folding mirror. The folding mirror is configured to direct the light from the light source to illumination optics 1304. Although the illumination optics are shown in FIG. 13 as including a single refractive lens, the illumination optics may include a variety of different optical elements (not shown in FIG. 13). For example, the illumination optics may include non-imaging, beam shaping optics. In one such example, cylindrical lens assemblies or DOEs can be used to shape a beam footprint to a single line (e.g., for a line scanning system configuration) or a rectangular footprint that matches a 2D or array detector. The illumination optics may also be configured to shape the beam in a pupil plane of the illumination subsystem to adjust illumination angles for best cell contrast. The illumination optics may further be configured to adjust illumination polarization (while detection polarization may be adjusted by polarizing component 1272 shown in FIG. 13) for best cell contrast.

The detection subsystems for single or multiple spot imaging such as that shown in FIG. 12 may be slightly different than the detection subsystems for line or flood illumination. For example, in the embodiment shown in FIG. 13, collection optics 1246 may be imaging quality collection optics having an NA of 0.5 NA to 0.9 NA or even larger. The detection subsystem shown in FIG. 13 may also include pupil splitter 1248, which may be configured as described above, but in this embodiment the portion of the NA that is directed to the fluorescent channels may be about 0.2 NA to about 0.6 NA.

The elastic channel of the detection subsystem shown in FIG. 13 may also be different from that used for single or multi-spot scanning. For example, in the detection subsystem shown in FIG. 13, light from the cells that is not reflected by the pupil splitter to the fluorescent channels may be directed to zoom lens 1306 that is configured to focus light from the collection optics to detector 1308 that may be an area or line scan camera. In one such example, for line scanning, the detector may include a line sensor while, for flood imaging, the detector may include a time delay integration (TDI) camera or a CMOS frame camera. In this manner, the area or line scan camera, together with other optical elements of the detection subsystem, may form a scattering (e.g., relatively high NA, non-specular (elastic)) imaging channel.

In another embodiment, the illumination subsystem is configured to focus the light to more than 100,000 of the cells immobilized in the device in a single run by flood illumination. For example, the illumination subsystem may be configured to illuminate a substantial area within the device and therefore a substantial number of cells in the device simultaneously with flood illumination. In addition, a flood illumination based system may be configured to scan light over the device as described further herein (e.g., by moving the device with respect to the optical elements of the system). Therefore, the illumination subsystem may be configured to illuminate a substantial number of the cells (e.g., more than 100,00) in the device simultaneously or via scanning.

In another embodiment, the output includes images, and the detection subsystem includes one or more line scan cameras configured to operate above 1 million lines per second. For example, the output of the detection subsystem may include images obtained by line scanning. In addition, the images may be collected using relatively fast line scan cameras that operate above 1 mega lines per second at above 1000 pixels per line. In some embodiments, the output includes images, and the detection subsystem includes one or more array detectors configured to operate at above 100 million pixels per second. For example, the output of the detection subsystem may include images obtained by area image sensor(s). In addition, the images may be collected using TDI cameras or CMOS images sensors that operate at above 1 billion pixels per second.

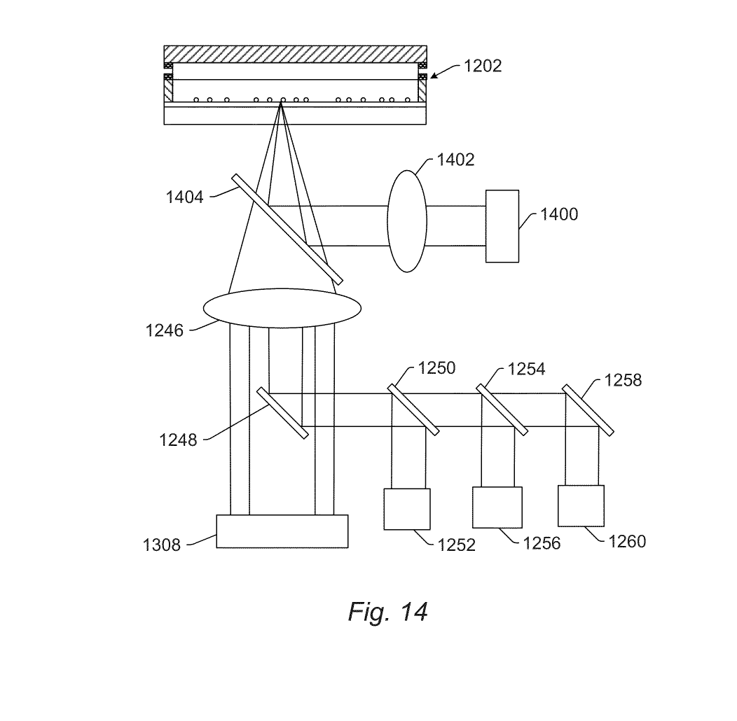

Although FIGS. 12 and 13 show the illumination and detection subsystems being located on opposite sides of the device, the illumination and detection subsystems may be located on the same side of the device, which may be advantageous for a number of different reasons. In one such embodiment shown in FIG. 14, the system can be configured for optional spot or line scanning with illumination and collection on the same light path. For example, in this embodiment, the illumination subsystem includes light source 1400 that may be a CW laser or any other suitable light source. The light source is configured to direct light to illumination optics 1402 that may include a spot or line forming lens. The illumination optics may direct the light to dichroic beam splitter 1404 that is configured to direct relatively short wavelength illumination to device 1202. The dichroic beam splitter may also be configured to allow light reflected, scattered, or emitted from the cells in the device having longer wavelengths to pass through the beam splitter to collection optics 1246, which may be configured as described herein. Collection optics and other elements of the detection subsystem shown in FIG. 14 may be configured as described further herein.

In one embodiment, the output includes multiple images of light in defined spectral bands that are collected and detected simultaneously. For example, the detection subsystem may be configured to generate images for each of many wavelengths so that each image pixel contains a spectral distribution of the captured light (fluorescence, transmission, or scattering). In some instances, spectral content between 400 nm and 900 nm of each pixel is collected. For example, in one embodiment, the output is responsive to the light from the cells having wavelengths between 400 nm and 900 nm. Spectral imaging of emitted light can be collected in a spot scanning system described herein by directing the collected light to a spectrophotometer, where the light is spread out over a line sensor according to emitted wavelength, and the spectra are collected in a time sequence corresponding to sequential image pixels scanned by the spot. In a 2D flood or 1D line scanning system, the excitation light wavelength can be scanned using a prism and a spatial light modulator that allows excitation wavelength to vary over time. The time-sequenced images can be re-ordered so as to create a “stack of images” that correspond to different excitation wavelengths per image (see, Proc. of SPIE, Vol. 7210, 721008-2, which is incorporated by reference as if fully set forth herein).

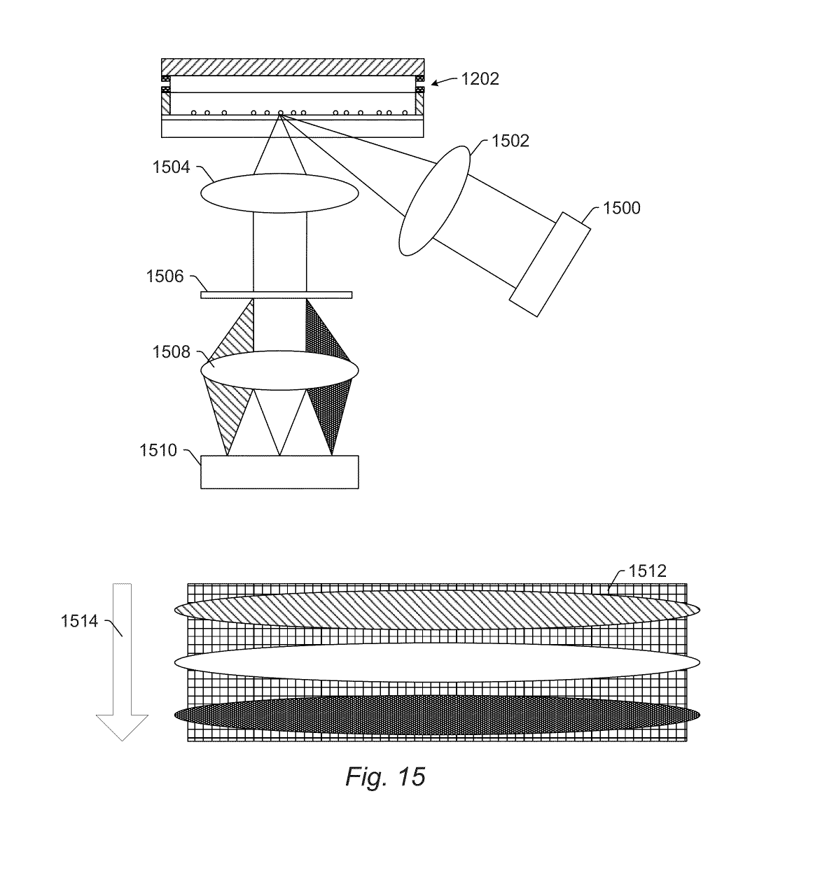

FIG. 15 illustrates one embodiment of a system configured for line scanning with spectral resolution. As shown in FIG. 15, the illumination subsystem includes light source 1500 that may be a pulsed (e.g., about 1 KHz) laser. The illumination subsystem also includes line forming illumination lens 1502 configured to direct light from the light source to device 1202. The line is formed by the lens in a direction into the page. Light reflected, scattered, and/or emitted by the cells in the device may be collected by imaging collection lens 1504 of the detection subsystem. The imaging collection lens may also be configured as or include a broadband pupil relay. The detection subsystem also includes diffraction grating 1506 configured to disperse the emitted light according to wavelength with different wavelengths shown in FIG. 15 by different light beams having different formatting. The detection subsystem also includes re-imaging lens 1508 configured to focus light from the diffraction grating to area detector 1510. As shown by top view 1512 of the area detector, multiple lines of different wavelengths may be imaged on the detector simultaneously and are shown by the elongated ellipses having different formatting that corresponds to that shown by the light beams focused to the area detector. The area detector frames are clocked out after each laser pulse thus imaging “spectral lines” that are collected as the stage moves one pixel between each pulse in the direction shown by arrow 1514.

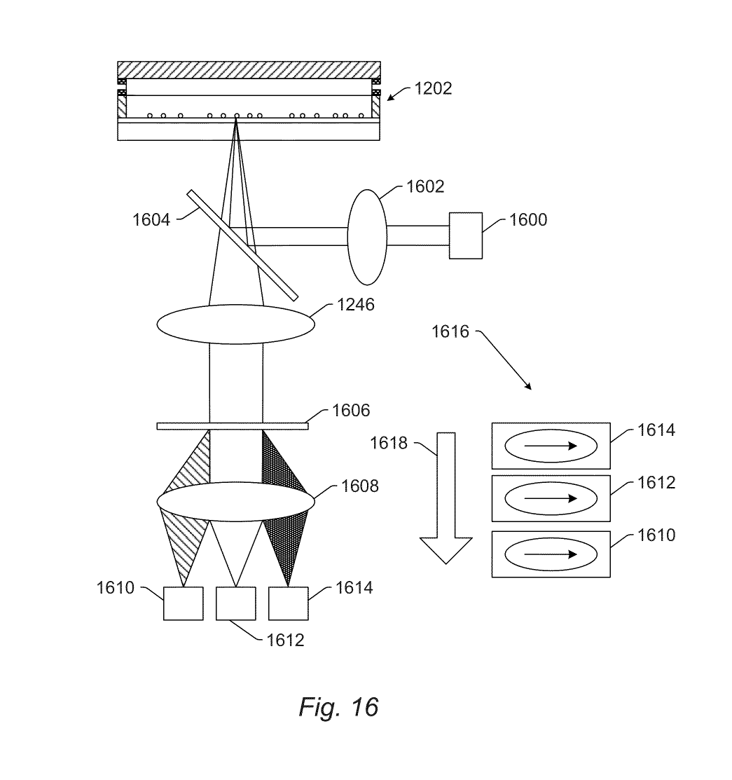

FIG. 16 illustrates one embodiment of a system configured for spot scanning with spectral resolution. As shown in FIG. 16, the illumination subsystem includes light source 1600 that may be a CW laser. The illumination subsystem also includes spot forming lens 1602 that is configured to direct light from the light source to dichroic beam splitter 1604 that is configured to direct relatively short wavelength illumination to device 1202. The dichroic beam splitter may also be configured to allow light reflected, scattered, and/or emitted from the cells in the device having longer wavelengths to pass through the beam splitter to collection optics 1246, which may be configured as described herein. For example, the collection optics may include a collection lens and pupil relay. Collection optics and other elements of the detection subsystem shown in FIG. 16 may be configured as described further herein.

The detection subsystem also includes diffraction grating 1606 configured to disperse the emitted light according to wavelength with different wavelengths shown in FIG. 16 by different light beams having different formatting. The detection subsystem also includes re-imaging lens 1608 configured to focus light from the diffraction grating to different detectors 1610, 1612, and 1614, each of which may be configured to detect light having a different wavelength. Each of the detectors may be an avalanche photodiode. In this manner, the detection subsystem may include an avalanche photodiode array. As shown by top view 1616 of the detectors, multiple spots of different wavelengths may be imaged on different detectors 1610, 1612, and 1614 simultaneously and are shown by the elongated ellipses. The arrows in the elongated spots indicate the direction of the spot sweep, and arrow 1618 shows the direction of stage movement.

In another embodiment, the output generated by the detection subsystem includes data in the form of a spectrum for each pixel with at least 10 samples across the spectrum. For example, each of the embodiments described above in which light is detected across a spectrum of wavelengths may be configured to sample the spectrum in any suitable manner and with any suitable number of samples. In addition, the spectrum from each pixel may be obtained by scanning a line across the cells and spreading the spectrum from the line onto an area detector.

In one embodiment, the computer subsystem is configured to generate output containing identifications for the cells and their correlated positions within the device in a form that is accessible and usable by another system to perform one or more functions on selected cells in the device. For example, additional embodiments are described herein in which the system is configured to use information about the cells and their correlated positions to perform one or more additional functions on the cells (e.g., review, treatment, removal, etc.). However, the system may also output this information to another, completely separate system so that this other system can use the information to perform one or more functions on the cells. The other system may be a cell review, treatment, removal, etc. system. In some such embodiments, the information correlating cell ID with within-device positions may be sent to a database or computer-readable storage medium that is accessible by multiple systems and in a format that is readable and usable by those other systems.

In one embodiment, the computer subsystem is configured to perform statistical analysis annotated with cell location data based on the one or more characteristics and the positions of the cells within the device. In one such embodiment, cell screening data can be displayed as one or more multi-parametric histograms in a manner similar to flow cytometers. However, unlike flow cytometry, each cell has an addressable location and a full complement of images available.

In another embodiment, the computer subsystem is configured to classify the cells into groups based on the one or more characteristics. For example, the computer subsystem may classify the cells into groups by analyzing screening data to assign cells in groups using characteristic-based criteria. Cell groups can be determined using image channel characteristics where certain ranges of characteristic values or combinations of characteristic values can determine which group any cell belongs to. Grouping the cells in this manner can be called “gating” in the parlance of flow cytometry. In general, this is some sort of logic-based combination of characteristic tests, where each test is some quantitative comparison for that characteristic or combination of characteristics. The cell characteristics can be displayed in a scatter plot where two characteristics can be selected for the X and Y axes, and each cell is a dot corresponding to its X axis characteristic value and Y axis characteristic value. Some graphical tools allow more than two axes to be represented in higher dimensional scatter plots. Users can manually draw boundaries in any of these multidimensional scatter plots guided by the “clumpiness” of the dots. The user can also use the computer subsystem to apply logical combinations of characteristic tests and observe the boundaries set by those tests against the scatter plot distribution, then adjust test parameters or logical combinations.

In some embodiments, the computer subsystem is configured to select only a portion of all of the cells for review based on the one or more characteristics. For example, the embodiments described herein may be configured to review selected cells in which the system returns to locations, based on cell image data collected in the screening step, for further analysis that may employ different optical measurements. In another such example, the computer subsystem may be configured for imaging software database tracing to review image results and select cell(s) for further review. In this manner, the computer subsystem may drive the review plan from the screening data. The computer subsystem may select representative cell locations from any “group of interest.” The computer subsystem may first select one of the groups into which the cells have been assigned by the computer subsystem. The computer subsystem may then review the images for representative cells in that group and select “typical” cells or simply randomly select cells from this group. In addition, the computer subsystem may determine the best sequence for visiting cell locations and reviewing cells. The computer subsystem may also select cells in groups using characteristic-based criteria. The computer subsystem may then generate output for the selected cells that includes any of the information generated for the cells by the embodiments described herein. For example, the computer subsystem may use a database such as that described herein that tracks the cell ID, cell location, and characteristic data to output the information in the database for the selected cells as a sample for cell review. That information may then be used for any of the cell review described herein. Any of the cell review described herein may include generating new output for the cells that are selected. Like the output generated during screening, that output can be associated with each cell at each location.

In another embodiment, the system is configured to reposition one or more of the cells selected for review in a FOV of the illumination and detection subsystems based on the positions within the device correlated with the one or more cells. For example, the computer subsystem may generate a database as described above that tracks the cell ID, cell location, and any characteristic data that was determined by the computer subsystem and use that database to reposition the selected cells for review. In this manner, additional image data may be collected from the selected cells using the same imaging optics that are used for screening of the cells.

In some embodiments, the system is configured to alter one or more parameters of the illumination subsystem, the detection subsystem, or the illumination and detection subsystems, the illumination and detection subsystems are configured to generate additional output responsive to light from only a portion of all of the cells with the one or more altered parameters, the portion of all of the cells was selected for review, and the computer subsystem is configured to determine one or more additional characteristics of the cells based on the additional output. For example, additional image data may be collected for any of the cells using the same imaging optics that are used for screening the cells, and the review images can be obtained using different optical parameters than those that are used during the screening step. In one such example, the pixel size or wavelength selections can be refined to obtain more information or higher spatial resolution for fewer cells at greater acquisition time per cell. In another such example, a spectral image can be obtained as described herein and shown in FIG. 15 where the imaging time per pixel is typically 100× longer than images acquired at discrete wavelengths. The additional output may be used to determine the one or more additional characteristics of the selected cells as described herein.

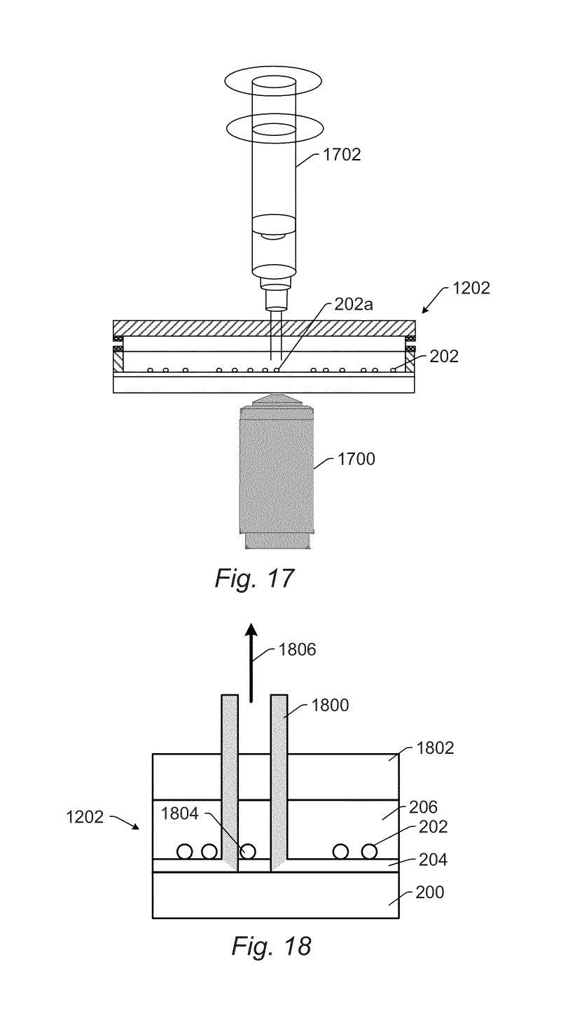

In some embodiments, the system includes a cell review subsystem configured to generate additional output responsive to additional light from the cells and the features with one or more parameters that are different than one or more parameters used by the illumination and detection subsystems to generate the output, and the computer subsystem is configured to determine one or more additional characteristics of the cells based on the additional output. For example, as shown in FIG. 17, the system may include cell review subsystem 1700 (shown only as a high resolution objective for simplicity but could include many of the subsystems described herein) configured to generate additional output responsive to additional light from the cells and the features. Although individual optical elements of the cell review subsystem are not shown in the figures, the cell review subsystem may be configured in a manner similar to the inspection subsystem shown in the figures. However, since cell review will be performed using one or more parameters that are different than the one or more parameters used for screening, the cell review subsystem may be configured as the optical subsystems are shown herein but with one or more elements that are different from the inspection subsystem (e.g., a different light source, different imaging optics, different detectors, etc.) or with one or more different parameters for the optical elements described herein (e.g., different polarizations for the polarizing component, different wavelengths for the light source, etc.). In this manner, the system may include different imaging optics that are located in the same system (and possibly use the same device handling equipment) and so can easily locate the cells under these different optics. These different optics can be optimized to collect higher resolution images or additional image channel data.

The device can also be removed from the systems described herein and placed in a review imaging system in which the location of the device is carefully indexed. This situation is one that would benefit from landmark strategies so that landmark positions can be easily relocated and individual cell locations obtained from single images containing that landmark. Having multiple options for cell review including any of those described herein allows users to choose the imaging system of their preference in the review step.

Regardless of how review is performed, cell review may use multiple image channel output or data. For example, as described further herein, the screening optics may include multiple channels, each configured to generate output from cells. During review, any or all of the multiple channels may be used to generate image channel data that is used to determine one or more additional characteristics of the cells. A cell review system or subsystem may also include multiple channels that can be used to generate output from the selected cells. Multiple channels may provide an opportunity to verify that any or each of the cells selected from a group have image properties that truly indicate that they should be members of that group. In addition, different imaging conditions (e.g., different excitation or emission wavelength ranges) can be used for screening and review in order to further classify or strengthen classification of cells into groups.

Higher resolution or greater contrast output can be obtained to verify cell characteristics. Such review can be helpful when attempting to identify rare cells that may have feature properties close to that of non-rare cells in the population. Furthermore, reviewing cells may be performed using a number of different optical techniques such as fluorescence, scattering, BF (phase), Raman, confocal, or some combination thereof. The review may also include acquiring 3D image data. In this manner, smaller sub-populations of cells can be re-imaged at higher resolution or using different imaging methods (e.g., Raman, 3D, confocal). Furthermore, the review may be performed at a number of different times prior to, during, or after treatment (e.g., to monitor changes in cell characteristics over time (after treatment)). In addition, a cell review subsystem described herein may be configured to collect additional output responsive to the cells in one or more timed events synchronized to treatment of the cells by the cell treatment subsystem.

Cell review may be performed slower than cell screening if cell review is performed with different parameters than screening. For example, cell review may be performed at a “medium” speed of 1 to 5 seconds per cell. In another example, reviewing cells may be performed at a rate of about 100 cells per minute. In particular, during review, higher quality image data and/or higher information content image data may be collected from cells (e.g., for review of rare cells for identification), but often these images take longer to collect than those obtained during screening. By selecting cell group representatives, one can reduce the cell count by factors of 10 or even 1000, thus allowing slower image data collection to be performed on a smaller set of cells thereby keeping overall review and analysis time within reasonable bounds.

In one embodiment, the computer subsystem is configured to select one or more of the cells for removal from the device based on the one or more characteristics. The computer subsystem may use any of the information for the cells generated by review and/or screening to select certain cells for retrieval. In addition, the computer subsystem may drive the selection plan for removal from screening, treatment, and/or review data. In one such example, the computer subsystem may be configured for imaging software database tracing to review image results and select cell(s) for retrieval. In addition, the computer subsystem may determine the best sequence for visiting cell locations and removing cells. Furthermore, as described further herein, the computer subsystem may use cell location information determined by the computer subsystem to guide the retrieval process and equipment. In addition, the system provides imaging means to guide cell removal as described further herein.

In one such embodiment, the system includes a cell removal device configured to remove only the one or more selected cells from the device based on the positions within the device correlated with the cells. In this manner, the system allows the removal of cells based on their determined characteristic(s) (used for selecting the cells) and their determined location(s). For example, as shown in FIG. 17, the system may include cell removal device 1702 configured to remove only the selected cell(s) from device 1202. Although the cell removal device is shown in FIG. 17 as a syringe, it is to be understood that this schematic representation is for the sake of simplicity only and the cell removal device may actually be configured according to any of the embodiments described herein. The computer subsystem may be configured to use cell locations determined as described herein to guide the retrieval process and equipment. Cells are typically 10 microns in diameter, and cell spacing within the device may be on the order of 50 microns. Therefore, cell location accuracy of the cell removal device should be in the 5 to 10 microns accuracy range.

In some embodiments, the system includes a cell removal device configured to extract one of the cells from the device by aspirating the one of the cells and one or more materials that immobilize the one of the cells in the device. For example, if the cells are immobilized in a gel matrix as described herein, then the cell removal device may include a gantry robot that can position a coring needle attached to an aspirating pump. In this manner, a cylinder of gel containing the cell of interest can be removed and dispensed in another container. In one such example, as shown in FIG. 18, the cell removal device may include a needle (tip 1800 of which is shown in FIG. 18) that is inserted into device 1202 such that the needle penetrates into and through any media 1802 formed on top of the device, one or more materials 206 such as a soft gel, and hard gel layer 204. The needle may be a relatively fine needle aspirator (e.g., having an outside diameter of about 0.10 mm and an inside diameter of about 0.05 mm). In this manner, one of cells 202 (e.g., cell 1804) and any portions of the device proximate to and above the one cell can be forced into the tip of the needle and then aspirated out of the device as shown by arrow 1806. As such, the cell removal device may aspirate media 1802 and the soft and hard gels with the selected cells.

The cell removal device may include a liquid handling gantry robot (not shown) configured to position the needle above the selected cells on a cell-by-cell basis. The liquid handling gantry robot may be controlled by the computer subsystem described herein based on the positions of the cells within the device correlated with individual cells such that only the selected cells are removed from the device. Cell aspiration can also be guided using a cell review subsystem as described further herein.

In another embodiment, the system includes a cell review subsystem configured to generate additional output responsive to additional light from the cells and the features with one or more parameters that are different than one or more parameters used by the illumination and detection subsystems to generate the output, the computer subsystem is configured to position the one of the cells in a FOV of the cell review subsystem and to alter a position of the cell removal device based on the additional output generated by the cell review subsystem in the FOV. For example, as shown in FIG. 17, the system may include cell review subsystem 1700 that may be configured as described further herein, and the computer subsystem (not shown in FIG. 17) may be configured to position one of the cells 202 (e.g., cell 202a) in the FOV of the cell review subsystem as shown in FIG. 17 and to alter a position of cell removal device 1702 based on the additional output generated by the cell review subsystem in the FOV. In this manner, the system may be configured to use images or other output generated by the cell review subsystem to position the cell removal device above the selected cell.

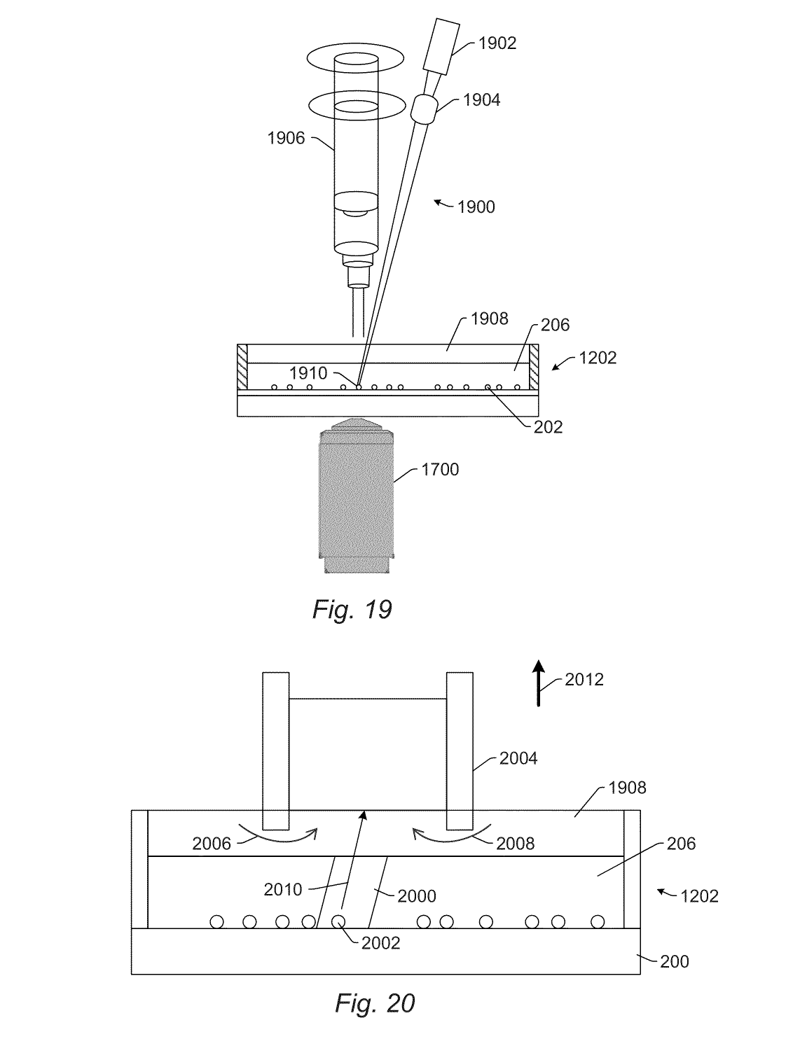

In one embodiment, the cell removal device includes an illuminator configured to direct light to the one or more materials that immobilize the one of the cells, the light from the illuminator alters flow characteristics of the one or more materials that immobilize the one of the cells, and the cell removal device aspirates the one or more materials having the altered flow characteristics and the one of the cells. For example, in one embodiment, the cell removal device includes illuminator 1900 shown in FIG. 19. The illuminator includes light source 1902 configured to generate light that is directed to cells 202 in device 1202 by one or more optical elements 1904 that may include any suitable optical elements known in the art such as refractive lenses. The cell removal device shown in FIG. 19 also includes aspirator 1906. Although aspirator 1906 is shown schematically in FIG. 19 as a manually operable syringe for the sake of simplicity, the aspirator may include any mechanical and/or robotic assembly known in the art such as a syringe pump.

As shown in FIG. 19, the illuminator may be configured to direct light to one or more materials 206 and any media 1908 formed on the one or more materials directly above cell 1910 selected for removal. The light directed to the one or more materials may include relatively low NA light (e.g., UV or blue light having an NA of about 0.03), or an NA sufficient to form an approximately 50 um cylinder above cell 1902, that, by altering flow characteristics of the one or more materials that immobilize the selected cell, can form an “escape cylinder” above the selected cell and within the non-illuminated portion of the materials. As further shown in FIG. 19, the system may also include cell review subsystem 1700 that may be configured as described herein and can be used to position the illuminator and the aspirator above the selected cell. For example, the cell review subsystem can be used to locate the cell of interest and guide cell aspiration.

In some embodiments, the one or more materials include one or more photo-depolymerizable gels. For example, if the cells are immobilized in a photo-depolymerizeable gel, then a beam of light can be focused through the gel to the volume of interest containing the cell. The gel will liquefy and allow a liquid aspiration tip to withdraw the liquid containing the cell. For example, as shown in FIG. 20, beam of light 2000 from illuminator 1900 shown in FIG. 19 can be focused through a gel that forms one or more materials 206 thereby illuminating a volume of the one or more materials containing cell 2002 selected for removal. The volume of “liquefied gel” may have a cylindrical shape and a diameter of about 10 microns to about 20 microns. Tip 2004 of an aspirator such as aspirator 1906 shown in FIG. 19 can be positioned above the illuminated volume of the one or more materials and can withdraw the liquid containing the cell 2002 in directions 2006, 2008, 2010, and 2012. Aspiration from media above the gel will bring up only the cell in the liquefied gel region. In this manner, the media can be aspirated with only the selected cell. In this case, the tip location and size can be relaxed (larger than a 50 micron tip at 5 to 10 microns accuracy) since only the cell of interest will be allowed to flow into the tip. In particular, the location accuracy and needle dimension requirements are greatly reduced compared to the gel “coring” approach described herein. For example, a liquid handling gantry robot with a relatively blunt needle aspirator (e.g., a needle aspirator having an outside diameter of about 0.3 mm and an inside diameter of about 0.25 mm) can be used for aspiration.

In some embodiments, the cell removal device includes an illuminator configured to direct light to the one or more materials that immobilize the one of the cells, the light from the illuminator modifies the one or more materials that immobilize the one of the cells and releases the one of the cells from the one or more materials that immobilize the one of the cells, and the cell removal device aspirates the released one of the cells. For example, the cell removal device may be configured to photo-release selected cells from chemical linkers or other molecules used for cell adhesion spots. In one such embodiment, the illuminator may be configured to direct relatively low NA light to the one or more materials thereby inducing “photo-cleavage” that can break the bonds that hold cell adhesion molecules to the substrate of the device for a selected cell. In this manner, aspiration from above the selected cell will bring up only the cell that has been photo-released and any other media surrounding or proximate to the cell without bringing up other cells located adjacent to the selected cell on the substrate. This cell removal device may be further configured as described herein and shown in FIG. 19.

In another embodiment, the one or more materials include photo-detachable linker molecules that bind to the cells and are attached to a substrate of the device in spots on the substrate. For example, if the cells are immobilized in a photo-depolymerizable array of adhesion spots, then a beam of light can be focused through the liquid to the spot of interest binding the cell. The cell will lose adhesion to the spot, which will allow a liquid aspiration tip to withdraw the liquid containing the cell. In this case, the tip location and tip size can be relaxed (larger than a 50 micron tip at 5 to 10 microns accuracy) since only the cell of interest will be allowed to flow into the tip.

Regardless of how the cells are retrieved, retrieval preferably maintains cell viability. Accordingly, the embodiments described herein are optimized for live cell extraction. In this manner, selected cells may be further treated after removal and other features analyzed or time dependent reactions observed. In addition, selected cells may be cultured or made to reproduce so as to perform analysis on entire culture fields, to harvest desired materials made by that cell, or to generate enough cell material for subsequent analysis such as molecular analysis or genome sequencing. For example, individual cells, or a small number of representative cells, may be removed for destructive but highly informative tests such as mass spectrometry to profile single cell proteome or whole genome sequencing of each cell. Cell retrieval may be performed at a relatively low speed (e.g., tens of seconds per cell or tens of cells per minute).

In one embodiment, the computer subsystem is configured to select only a portion of all of the cells for treatment based on the one or more characteristics. The cells may be selected for treatment using the characteristic(s) determined by screening and/or review. In this manner, the computer subsystem may drive the treatment plan from screening and/or review data. For example, the classification or grouping methods described above can be used by the computer subsystem to select cells for treatment, but the selected cells may include even fewer cells than those selected for review given the potentially longer time involved in treating cells versus reviewing cells. Cell treatment may be performed at a rate of about tens of cells per minute.

In another embodiment, the system includes a cell treatment subsystem configured to alter the environment of the cells within the device without altering the positions of the cells within the device. For example, the cell treatment subsystem may include a robotic liquid handling system (such as offered by Tecan or Beckman-Coulter) in which individual cells can be treated by delivering the treatment reagent in liquid form to the area in which each selected cell is located. If cells are immobilized in a gel, the delivery may involve inserting a syringe needle into the gel above the cell then injecting treatment liquid. Cell culture media refresh flow may be halted while cells are exposed to treatment liquids. In this manner, the cell treatment subsystem may be configured as shown in FIGS. 17 and 19, but instead of being configured for liquid aspiration as for cell removal, the syringe needles shown in these figures may be configured for liquid or fluid delivery and the syringe needles may be actually configured as the robotic liquid handling systems described above that may be controlled by a computer subsystem described herein.

Cell treatment can re-stain or expose the cells to cell-effecting agents or new cells. For example, cell treatment can be performed to introduce new labeling molecules that may be used to further classify the cells or strengthen cell classification in a given group. Cell treatment may also involve a stimulant or trigger (e.g., chemical, optical, or other triggers) that induces cellular changes that can be observed after subsequent cell review imaging. For example, a sub-population of the cells in the device can be treated chemically or by other triggers and time course imaging directly after triggering can quantify the response of the cells. A sub-population of the cells in the device may also be studied with greater sophistication such as by introducing particles or even other cells as the stimulus. Such treatment may involve careful timing and time sequence image data collection. The embodiments described herein can be optimized for time course review and trigger timing (e.g., by having screening, review, and treatment capabilities all in one system that can be controlled by a single computer subsystem). In addition, cells can be re-screened after additional staining or treatment.

In a further embodiment, the system includes a cell review subsystem configured to generate additional output responsive to additional light from the cells and the features with one or more parameters that are different than one or more parameters used by the illumination and detection subsystems to generate the output, and the computer subsystem is configured to alter a position of a cell treatment subsystem based on the additional output generated by the cell review subsystem. In addition, the computer subsystem may determine the best sequence for visiting cell locations and treating cells. In this manner, the system provides imaging means to guide cell treatment. Such systems may be configured as shown in FIGS. 17 and 19, but with the liquid handling systems shown in these figures configured for cell treatment rather than cell removal.

Each of the system embodiments described above may be configured to perform any step(s) of any method(s) described herein. In addition, each of the system embodiments described herein may be configured according to any other embodiments or systems described herein.

Another embodiment relates to a method for determining information from cells. The method embodiments described herein may be performed using the device and system embodiments described herein. In this manner, the method may be used to test a relatively large collection of cells.

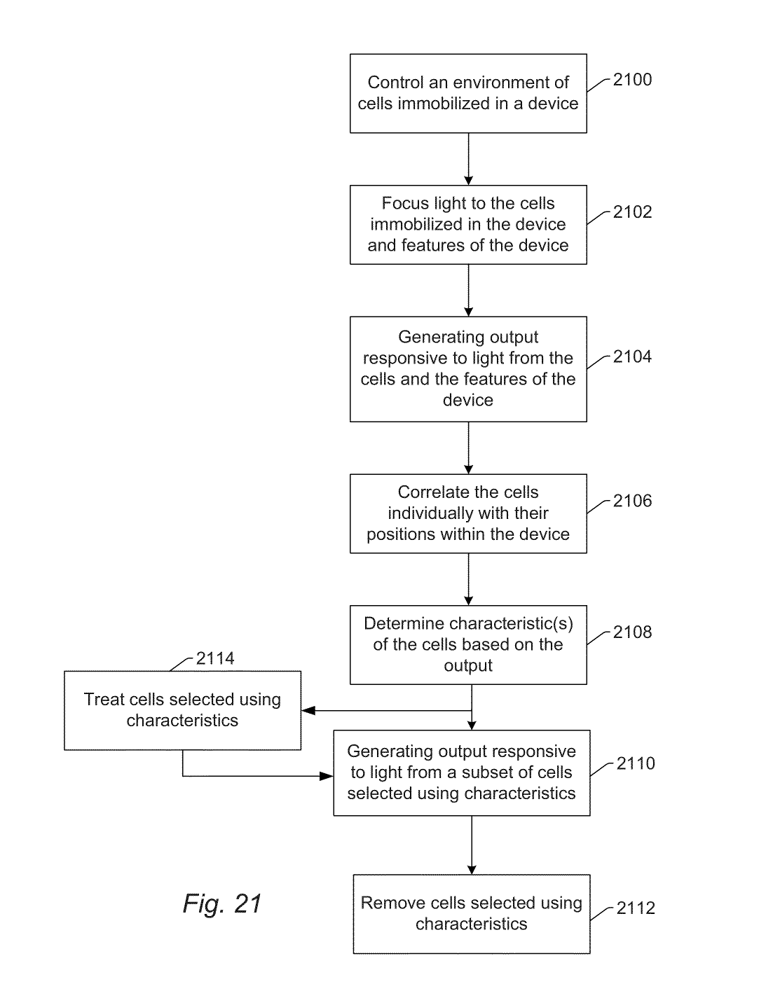

The method includes controlling an environment of cells immobilized in a device, as shown in step 2100 of FIG. 21, while the device is being used for the method without altering positions of the cells within the device. For example, controlling the environment may include refreshing or exchanging the chemical and/or physical environment of the cells without losing cell location tracking capability. Controlling the environment may also be performed according to any other embodiments described herein.

In one embodiment, controlling the environment maintains viability of the cells, which may be performed as described further herein. For example, the cells can be kept alive by media refresh methods and systems described herein and by other controls (e.g., keeping the temperature at about 37 degrees Celsius). In another embodiment, controlling the environment includes altering a fluid environment of the cells within the device by creating a thin flowing region above the cells, which may be performed as described further herein. In this manner, fluid exchange can be performed by creating a relatively thin flowing region above the cell field.

The device has features used by the method for separately determining and tracking the positions of each of the cells in the device on a cell-by-cell basis. The method can separately determine and track the positions of each of the cells as described further herein. The device can be configured according to any of the embodiments described herein. For example, in one embodiment, more than 100,000 of the cells are immobilized in the device. In some embodiments, the cells in the device for which the method is performed include more than 100,000 cells. For example, the method may be performed for a collection of more than 100,000 cells or even 10 million cells.

In another embodiment, the device is configured to immobilize the cells to thereby allow the focusing and generating steps of the method to be performed with substantially high resolution. In this manner, a relatively large collection of cells (e.g., hundreds of thousands to millions of cells) can be immobilized in a manner suitable for high resolution imaging.

In some embodiments, as described further herein, the device is configured to immobilize the cells with adhesion molecules attached to a substrate in a collection of spots. In one such embodiment, the method includes directing energy to one or more of the spots, which may be performed as described further herein, and the energy causes the adhesion molecules at the one or more of the spots to release the cells immobilized therein.

In one embodiment, the method includes immobilizing the cells in the device by injecting a suspension of the cells and one or more materials into the device and treating the one or more materials to form a gel that immobilizes the cells in the device, which may be performed as described further herein. In one such embodiment, the method includes releasing one or more of the cells from the gel by de-polymerizing at least a portion of the gel, which may be performed as described further herein.

In one embodiment, the method includes arranging the cells on a single layer resting on or near the substrate surface of the device.

The method also includes focusing light to the cells immobilized in the device and the features of the device, as shown in step 2102 of FIG. 21, which may be performed as described further herein. For example, in one embodiment, focusing the light to the cells includes scanning the light over the cells while generating the output, and the output is generated for more than 1 million cells in less than 10 minutes. For example, the imaging speed of the methods described herein may be faster than 1 million cells per 100 minutes, 1 million cells per 10 minutes, or even 1 million cells per minute.

In another embodiment, focusing the light includes focusing multiple spots of the light to the cells simultaneously. In some embodiments, focusing the light to the cells includes focusing a single spot of the light to the cells. In a further embodiment, focusing the light to the cells includes illuminating the cells with line illumination. In an additional embodiment, focusing the light to the cells includes illuminating the cells with flood illumination. Focusing the light to the cells in each of these manners may be performed as described further herein.

In some embodiments, the method includes altering one or more characteristics of the light focused to the cells, and the one or more characteristics include one or more wavelengths of the light, one or more polarizations of the light, a shape of the light focused to the cells, one or more illumination angles, or a combination thereof. Altering the characteristic(s) of the light focused to the cells may be performed as described further herein.

The method further includes generating output responsive to light from the cells and the features of the device, as shown in step 2104 of FIG. 21, which may be performed as described further herein. For example, in one embodiment, generating the output includes detecting the light from the cells and the features with multiple channels simultaneously, and the output includes different output generated by the multiple channels.

In another embodiment, generating the output includes detecting the light from the cells and the features with multiple channels simultaneously, which may be performed as described further herein, and the multiple channels include two or more channels configured to detect fluorescence emitted from the cells and one or more channels configured to detect light specularly reflected from, scattered from, or transmitted through the cells. In an additional embodiment, generating the output includes directing a portion of the light from the cells to one or more channels configured to detect fluorescence emitted by the cells and another portion of the light from the cells to one or more channels configured to detect light scattered by or transmitted through the cells, which may be performed as described further herein.

In some embodiments, focusing the light to the cells includes focusing multiple spots of the light to the cells simultaneously, and generating the output includes separating the light from the multiple spots into separate beams that are directed to different detectors. In another embodiment, generating the output includes detecting fluorescence emitted by the cells with multiple channels simultaneously. In some embodiments, the method includes altering one or more polarizations of the light from the cells prior to generating the output. Each of these steps may be performed as described further herein.

The method includes correlating the cells individually with their positions within the device based on the output responsive to the light from the cells and the features, as shown in step 2106 of FIG. 21, which may be performed as described further herein. In this manner, the method may include tracking cell locations of individual cells. Correlating the cells individually with their positions within the device allows the collected output (e.g., image data) to be associated with each cell on an individual cell-by-cell basis.

The method includes determining one or more characteristics of the cells based on the output responsive to the light from the cells, as shown in step 2108 of FIG. 21, which may be performed as described further herein. For example, in one embodiment, the one or more characteristics include a sampled spectrum of reflected, transmitted, scattered, or fluorescent light from the cells. In some embodiments, the method includes performing statistical analysis annotated with cell location data based on the one or more characteristics and the positions of the cells within the device, which may be performed as described further herein.

In another embodiment, the method includes classifying the cells into groups based on the one or more characteristics, which may be performed as described further herein. In a further embodiment, the method includes selecting only a portion of all of the cells for review based on the one or more characteristics. The methods described herein may include reviewing the cells after initial imaging. For example, as shown in step 2110 of FIG. 21, the method may include generating output responsive to light from a subset of cells selected using characteristic(s) of the cells during review. In one such embodiment, the method includes repositioning a cell selected for review in a FOV for focusing the light to the cells and generating the output based on the positions within the device correlated with the cells.

In another embodiment, focusing the light to the cells and generating the output are performed faster than 1,000 cells per 10 minutes for the review. In some embodiments, the method includes altering one or more parameters of focusing the light to the cells and/or generating the output, generating additional output responsive to light from only a portion of all of the cells with the one or more altered parameters, and the portion of all of the cells was selected for review. Such a method may also include determining one or more additional characteristics of the portion of all of the cells based on the additional output.

In another embodiment, the focusing and generating steps are performed with a cell inspection subsystem, and the method includes generating additional output responsive to additional light from the cells and the features with a cell review subsystem having one or more parameters that are different than one or more parameters used for the focusing and generating steps and determining one or more additional characteristics of the cells based on the additional output.

In another embodiment, the focusing and generating steps are performed for all of the cells within the device a first time and then the focusing and generating steps are performed for all of the cells within the device a second time. For example, the entire collection of cells in a device can be re-imaged, and re-imaging can be performed using one or more illumination and/or collection parameters that are different than those used for initial imaging (e.g., new wavelength(s), polarization, focal plane relative to cell position, etc.). In one such embodiment, one or more parameters of the focusing step and/or the generating step are altered between performing the focusing and the generating steps the first time and the second time.

In another embodiment, the method includes selecting one or more of the cells for removal from the device based on the one or more characteristics. As shown in step 2112 of FIG. 21, the method may then include removing cells selecting using the characteristic(s). In some embodiments, the method includes removing only a portion of the cells for analysis, processing, or growth external to the device. Removing only a portion of the cells may include removing only the cells selected for removal on an individual cell-by-cell basis. For example, removing the portion of the cells may include physically retrieving cells as described herein based on measured characteristics and locations.

In an additional embodiment, the method includes removing only a portion of the cells by coring one or more materials that immobilize the cells within the device with a needle. For example, as described further herein, cells can be immobilized in the device by a gel and removal can be performed by coring the portion of the gel containing the desired cell in a relatively small needle aspirator.

In a further embodiment, the method includes positioning a cell removal device proximate to one of the cells that has been selected for removal from the device based on additional output generated by imaging the one of the cells. For example, the cells can be identified and removed using image-guided methods and systems described herein.

In another embodiment, one or more materials immobilize the cells in the device, and the method includes removing only a portion of the cells by directing light to a portion of the one or more materials that immobilize only the portion of the cells to alter flow characteristics of the portion of the one or more materials and aspirating the portion of the one or more materials containing only the portion of the cells. For example, the cells may be immobilized in a gel that can be selectively depolymerized by use of light thereby allowing the cell(s) to be removed by fluid aspiration.

In some embodiments, one or more materials immobilize the cells in the device, and the method includes removing only a portion of the cells by directing light to a portion of the one or more materials that immobilize only the portion of the cells to release the portion of the cells from the portion of the one or more materials and aspirating only the released portion of the cells. For example, the cells may be immobilized using arrayed patches of affinity molecules that bind the cells to the substrate but can release the cells with directed light (e.g., via photocleavage).

Another embodiment of the method includes selecting only a portion of the cells for treatment based on the one or more characteristics. The method may then include treating the cells selected using the characteristics(s), as shown in step 2114 of FIG. 21. In another embodiment, the method includes treating only a portion of the cells in the device with one or more reagents. Some embodiments of the method include treating one or more of the cells in the device with one or more reagents, and the focusing and generating steps are performed on the one or more of the cells before and after the treating step. For example, selected cells or an entire population in a device may be treated chemically (e.g. using the same fluid exchange tools described herein) and then re-imaged (reviewed).

Additional embodiments of the method include stimulating one or more of the cells in the device with one or more stimuli, and the focusing and generating steps are performed on the one or more of the cells before and after the stimulating step. For example, the cells can be stimulated in some way (e.g., via light, pressure, introducing external cells, exposing cells to chemicals, etc.) prior to review.

Each of the steps of the method described above may be further performed as described herein. Each of the embodiments of the method described above may include any other step(s) of any other method(s) described herein. In addition, each of the embodiments of the method described above may be performed by any of the systems described herein.

As can be seen from the above description, the embodiments described herein provide a number of advantages over other currently used methods and systems for cytometry. For example, flow cytometers cannot acquire images of cells, return to or review individual cells, or select individual cells from an entire population after imaging. In addition, sorting flow cytometers cannot acquire images and can select cells but only within milliseconds of acquiring the data. In addition, selected cells are pooled and lose their specific identify. Furthermore, these cytometers provide no review capability unless the cells are re-run in the flow cytometer risking cell viability and loss of cells. Moreover, imaging flow cytometers have relatively poor image quality and provide no review or cell selection capability. Slide-based microscopy can only image relatively low numbers of cells, has a relatively low throughput (data rate) and relatively poor means to select cells, and has statistical and cell-by-cell data analysis tools that lack important capabilities. Multi-well plate-based microscopy can only analyze relatively low numbers of cells (per well), has a relatively low throughput (data rate) and relatively poor means to select cells, and has statistical and cell-by-cell data analysis tools that lack important capabilities.

In contrast, the embodiments described herein can be used to acquire relatively high resolution images from many (e.g., 100K to 10M) cells in a reasonable time (e.g., 1 minute to 30 minutes). In addition, the embodiments described herein provide multiple imaging options (e.g., multiple illumination/collection wavelength combinations, dark field or bright field, polarization control, focal plane control vs. cell section, etc.). The embodiments described herein also provide the ability to locate and identify each cell and track all image data against that specific cell identity and location. Furthermore, the embodiments described herein provide the ability to return to any given cell or cells and collect more image data (e.g., with different image configurations in some cases). In addition, the embodiments described herein are capable of keeping cells alive during the entire process. The embodiments described herein are also capable of treating selected cells (e.g., by adding chemicals or other stimuli to the cells). Furthermore, the embodiments described herein are capable of analysis of all of the generated output and reducing the output to cell characteristic(s) that can be used in available classification tools. The embodiments are further capable of performing statistical and data mining to vary the image processing and classification recipes and investigate detailed data behind the results. The embodiments are also capable of removing selected cells from the sample device. Preferably, the embodiments can perform such removing of the cells while maintaining cell viability. In addition, the embodiments described herein may include any combination of the above described capabilities (e.g., to make trade-offs between given capabilities and the cost and complexity of the systems or devices).

The embodiments described herein, therefore, provide superior cytometry and cell handling for a number of users such as disease and human health researchers, especially those that study primary cell collections (e.g., whole blood samples). In addition, other users who can benefit from the embodiments described herein include pharmaceutical research and development staff who participate in: target discovery, compound screening, cellular therapeutics discovery (such as stem cell studies), ADME toxicity studies, and patient profiling in clinical trials (both for small molecule and biopharma drugs). In addition, other users who can benefit from the embodiments described herein include researchers and clinical diagnostic lab operators who participate in rare cell detection and classification studies such as CTC detection.

Further modifications and alternative embodiments of various aspects of the invention will be apparent to those skilled in the art in view of this description. For example, systems and methods for determining information for cells are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system configured to determine information for cells, comprising:
an environmental control subsystem configured to control an environment of cells immobilized in a device while the device is positioned in the system without altering positions of the cells within the device, wherein the device has features used by the system for separately determining and tracking the positions of each of the cells in the device on a cell-by-cell basis;
an illumination subsystem configured to focus light to the cells immobilized in the device and the features;
a detection subsystem configured to generate output responsive to light from the cells and the features; and
a computer subsystem configured to correlate the cells individually with their positions within the device based on the output responsive to the light from the cells and the features and to determine one or more characteristics of the cells based on the output responsive to the light from the cells.

2. The system of claim 1, wherein the illumination subsystem comprises a laser sustained plasma light source configured to generate the light that is focused to the cells.

3. The system of claim 1, wherein the illumination subsystem comprises an arc lamp, wherein the system further comprises a stage configured to support and move the device, and wherein the stage and a detector of the detection subsystem are synchronized for movement and imaging of the cells within the device.

4. The system of claim 1, wherein the illumination subsystem comprises a pulsed laser, wherein the system further comprises a stage configured to support and move the device, and wherein the stage and a detector of the detection subsystem are synchronized for movement and imaging of the cells within the device.

5. The system of claim 1, wherein the illumination subsystem comprises a laser sustained plasma light source, wherein the system further comprises a stage configured to support and move the device, and wherein the stage and a detector of the detection subsystem are synchronized for movement and imaging of the cells within the device.

6. The system of claim 1, wherein the illumination subsystem is further configured to scan the light over the cells while the detection subsystem generates the output, and wherein the output is generated for more than 1 million cells in less than 10 minutes.

7. The system of claim 1, wherein the illumination subsystem is further configured to focus the light to more than 100,000 of the cells immobilized in the device in a single run by scanning the light over the cells.

8. The system of claim 1, wherein the illumination subsystem is further configured to focus the light to more than 100,000 of the cells immobilized in the device in a single run by flood illumination.

9. The system of claim 1, wherein the device immobilizes millions of the cells, and wherein the illumination and detection subsystems are configured such that the light can be focused to any of the millions of cells and such that the output can be generated for any of the millions of cells.

10. The system of claim 1, wherein the illumination subsystem is further configured to scan the light over the cells while the detection subsystem generates the output, and wherein the light is scanned at a rate faster than 1 millisecond per 1 mm sweep.

11. The system of claim 1, wherein the illumination subsystem comprises an acousto-optical device configured to scan the light over the cells while the detection subsystem generates the output.

12. The system of claim 1, further comprising a scanning subsystem configured to move the device while the illumination subsystem focuses the light to the cells and the detection subsystem generates the output, wherein the output is generated for more than 1 million cells in less than 10 minutes.

13. The system of claim 1, wherein the illumination subsystem is further configured to focus the light to the cells by focusing multiple spots of light to the cells simultaneously.

14. The system of claim 1, wherein the illumination subsystem is further configured to focus the light to the cells by focusing a single spot of light to the cells.

15. The system of claim 1, wherein the illumination subsystem is further configured to focus the light to the cells by line illumination of the cells.

16. The system of claim 1, wherein the illumination subsystem is further configured to focus the light to the cells by flood illumination of the cells.

17. The system of claim 1, wherein the illumination subsystem is further configured to alter one or more characteristics of the light focused to the cells, and wherein the one or more characteristics comprise one or more wavelengths of the light, one or more polarizations of the light, a shape of the light focused to the cells, one or more illumination angles, or a combination thereof.

18. The system of claim 1, further comprising an auto-focus subsystem configured to monitor and adjust a position of the cells with respect to a focal plane of the system while the output is generated by the detection subsystem.

19. The system of claim 1, wherein the detection subsystem comprises multiple channels configured to detect the light from the cells and the features simultaneously, and wherein the output comprises different output generated by the multiple channels.

20. The system of claim 1, wherein the detection subsystem comprises multiple channels configured to detect the light from the cells and the features simultaneously, and wherein the multiple channels comprise two or more channels configured to detect fluorescence emitted from the cells and one or more channels configured to detect light specularly reflected from, scattered by, or transmitted through the cells.

21. The system of claim 1, wherein the detection subsystem comprises a pupil splitter configured to direct a portion of the light from the cells to one or more channels configured to detect fluorescence emitted by the cells and another portion of the light from the cells to one or more channels configured to detect light scattered by or transmitted through the cells.

22. The system of claim 1, wherein the illumination subsystem is further configured to focus the light to the cells by focusing multiple spots of light to the cells simultaneously, and wherein the detection subsystem comprises an image plane splitter configured to separate the light from the multiple spots into separate beams that are directed to different detectors.

23. The system of claim 1, wherein the detection subsystem comprises multiple channels configured to detect the light from the cells simultaneously, and wherein the multiple channels comprise two or more channels configured to detect fluorescence emitted by the cells.

24. The system of claim 1, wherein the detection subsystem comprises one or more polarizing components configured to alter one or more polarizations of the light from the cells.

25. The system of claim 1, wherein the detection subsystem comprises one or more detectors configured to generate the output at a rate faster than 100 million output data samples per second.

26. The system of claim 1, wherein the output comprises image data, and wherein the detection subsystem comprises one or more photomultiplier tubes configured to operate at more than 100 million output data samples per second.

27. The system of claim 1, wherein the output comprises images, and wherein the detection subsystem comprises one or more line scan cameras configured to operate above 1 million lines per second.

28. The system of claim 1, wherein the output comprises images, and wherein the detection subsystem comprises one or more array detectors configured to operate at above 100 million pixels per second.

29. The system of claim 1, wherein the output comprises multiple images of light in defined spectral bands that are collected and detected simultaneously.

30. The system of claim 1, wherein the output is further responsive to the light from the cells having wavelengths between 400 nm and 900 nm.

31. The system of claim 1, wherein the output generated by the detection subsystem comprises data in the form of a spectrum for each pixel with at least 10 samples across the spectrum.

32. The system of claim 31, wherein the spectrum from each pixel is obtained by scanning a line across the cells and spreading the spectrum from the line onto an area detector.

33. The system of claim 1, wherein the computer subsystem is further configured to perform statistical analysis annotated with cell location data based on the one or more characteristics and the positions of the cells within the device.

34. The system of claim 1, wherein the computer subsystem is further configured to classify the cells into groups based on the one or more characteristics.

35. The system of claim 1, wherein the computer subsystem is further configured to select only a portion of all of the cells for review based on the one or more characteristics.

36. The system of claim 1, wherein the system is further configured to reposition one or more of the cells selected for review in a field of view of the illumination and detection subsystems based on the positions within the device correlated with the one or more cells.

37. The system of claim 1, wherein the system is further configured to alter one or more parameters of the illumination subsystem, the detection subsystem, or the illumination and detection subsystems, wherein the illumination and detection subsystems are configured to generate additional output responsive to light from only a portion of all of the cells with the one or more altered parameters, wherein the portion of all of the cells was selected for review, and wherein the computer subsystem is further configured to determine one or more additional characteristics of the cells based on the additional output.

38. The system of claim 1, further comprising a cell review subsystem configured to generate additional output responsive to additional light from the cells and the features with one or more parameters that are different than one or more parameters used by the illumination and detection subsystems to generate the output, wherein the computer subsystem is further configured to determine one or more additional characteristics of the cells based on the additional output.

39. The system of claim 1, wherein the computer subsystem is further configured to select one or more of the cells for removal from the device based on the one or more characteristics.

40. The system of claim 1, wherein the computer subsystem is further configured to select one or more of the cells for removal from the device based on the one or more characteristics, and wherein the system further comprises a cell removal device configured to remove only the one or more selected cells from the device based on the positions within the device correlated with the cells.

41. The system of claim 1, further comprising a cell removal device configured to extract one of the cells from the device by aspirating the one of the cells and one or more materials that immobilize the one of the cells in the device.

42. The system of claim 41, further comprising a cell review subsystem configured to generate additional output responsive to additional light from the cells and the features with one or more parameters that are different than one or more parameters used by the illumination and detection subsystems to generate the output, wherein the computer subsystem is further configured to position the one of the cells in a field of view of the cell review subsystem and to alter a position of the cell removal device based on the additional output generated by the cell review subsystem in the field of view.

43. The system of claim 41, wherein the cell removal device comprises an illuminator configured to direct light to the one or more materials that immobilize the one of the cells, wherein the light from the illuminator alters flow characteristics of the one or more materials that immobilize the one of the cells, and wherein the cell removal device aspirates the one or more materials having the altered flow characteristics and the one of the cells.

44. The system of claim 43, wherein the one or more materials comprise one or more photo-depolymerizable gels.

45. The system of claim 41, wherein the cell removal device comprises an illuminator configured to direct light to the one or more materials that immobilize the one of the cells, wherein the light from the illuminator modifies the one or more materials that immobilize the one of the cells and releases the one of the cells from the one or more materials that immobilize the one of the cells, and wherein the cell removal device aspirates the released one of the cells.

46. The system of claim 45, wherein the one or more materials comprise photo-detachable linker molecules that bind to the cells and are attached to a substrate of the device in spots on the substrate.

47. The system of claim 1, wherein the environmental control subsystem is further configured to maintain viability of the cells while the device is positioned in the system by controlling the environment of the cells within the device before, during, and after the detection subsystem generates the output.

48. The system of claim 1, wherein the computer subsystem is further configured to select only a portion of all of the cells for treatment based on the one or more characteristics.

49. The system of claim 1, further comprising a cell treatment subsystem configured to alter the environment of the cells within the device without altering the positions of the cells within the device.

50. The system of claim 49, further comprising a cell review subsystem that collects additional output responsive to the cells in one or more timed events synchronized to treatment of the cells by the cell treatment subsystem.

51. The system of claim 1, further comprising a cell review subsystem configured to generate additional output responsive to additional light from the cells and the features with one or more parameters that are different than one or more parameters used by the illumination and detection subsystems to generate the output, wherein the computer subsystem is further configured to alter a position of a cell treatment subsystem based on the additional output generated by the cell review subsystem.

52. The system of claim 1, further comprising a stage configured to support the device within the system and to maintain a predetermined and fixed position of the device on the support.

53. The system of claim 1, wherein the computer subsystem is further configured to generate output containing identifications for the cells and their correlated positions within the device in a form that is accessible and usable by another system to perform one or more functions on selected cells in the device.

54. A method for determining information for cells, comprising:
controlling an environment of cells immobilized in a device while the device is being used for the method without altering positions of the cells within the device, wherein the device has features used by the method for separately determining and tracking the positions of each of the cells in the device on a cell-by-cell basis;
focusing light to the cells immobilized in the device and the features of the device;
generating output responsive to light from the cells and the features of the device;
correlating the cells individually with their positions within the device based on the output responsive to the light from the cells and the features; and
determining one or more characteristics of the cells based on the output responsive to the light from the cells.

55. The method of claim 54, wherein more than 100,000 of the cells are immobilized in the device.

56. The method of claim 54, further comprising immobilizing the cells in the device by injecting a suspension of the cells and one or more materials into the device and treating the one or more materials to form a gel that immobilizes the cells in the device.

57. The method of claim 56, further comprising releasing one or more of the cells from the gel by de-polymerizing at least a portion of the gel.

58. The method of claim 54, wherein the cells in the device for which the method is performed comprise more than 100,000 cells.

59. The method of claim 54, wherein the device is configured to immobilize the cells to thereby allow said focusing and said generating to be performed with substantially high resolution.

60. The method of claim 54, wherein the device is configured to immobilize the cells with adhesion molecules attached to a substrate in a collection of spots.

61. The method of claim 60, further comprising directing energy to one or more of the spots, wherein the energy causes the adhesion molecules at the one or more of the spots to release the cells immobilized therein.

62. The method of claim 54, wherein said controlling maintains viability of the cells.

63. The method of claim 54, wherein said controlling comprises altering a fluid environment of the cells within the device by creating a thin flowing region above the cells.

64. The method of claim 54, wherein said focusing comprises scanning the light over the cells while generating the output, and wherein the output is generated for more than 1 million cells in less than 10 minutes.

65. The method of claim 54, wherein said focusing comprises focusing multiple spots of the light to the cells simultaneously.

66. The method of claim 54, wherein said focusing comprises focusing a single spot of the light to the cells.

67. The method of claim 54, wherein said focusing comprises illuminating the cells with line illumination.

68. The method of claim 54, wherein said focusing comprises illuminating the cells with flood illumination.

69. The method of claim 54, further comprising altering one or more characteristics of the light focused to the cells, wherein the one or more characteristics comprise one or more wavelengths of the light, one or more polarizations of the light, a shape of the light focused to the cells, one or more illumination angles, or a combination thereof.

70. The method of claim 54, wherein the one or more characteristics comprise a sampled spectrum of reflected, transmitted, scattered, or fluorescent light from the cells.

71. The method of claim 54, wherein said generating comprises detecting the light from the cells and the features with multiple channels simultaneously, and wherein the output comprises different output generated by the multiple channels.

72. The method of claim 54, wherein said generating comprises detecting the light from the cells and the features with multiple channels simultaneously, and wherein the multiple channels comprise two or more channels configured to detect fluorescence emitted from the cells and one or more channels configured to detect light specularly reflected from, scattered from, or transmitted through the cells.

73. The method of claim 54, wherein said generating comprises directing a portion of the light from the cells to one or more channels configured to detect fluorescence emitted by the cells and another portion of the light from the cells to one or more channels configured to detect light scattered by or transmitted through the cells.

74. The method of claim 54, wherein said focusing comprises focusing multiple spots of the light to the cells simultaneously, and wherein said generating comprises separating the light from the multiple spots into separate beams that are directed to different detectors.

75. The method of claim 54, wherein said generating comprises detecting fluorescence emitted by the cells with multiple channels simultaneously.

76. The method of claim 54, further comprising altering one or more polarizations of the light from the cells prior to said generating.

77. The method of claim 54, further comprising performing statistical analysis annotated with cell location data based on the one or more characteristics and the positions of the cells within the device.

78. The method of claim 54, further comprising classifying the cells into groups based on the one or more characteristics.

79. The method of claim 54, further comprising selecting only a portion of all of the cells for review based on the one or more characteristics.

80. The method of claim 54, further comprising repositioning a cell selected for review in a field of view for said focusing and said generating based on the positions within the device correlated with the cells.

81. The method of claim 80, wherein said focusing and said generating are performed faster than 1,000 cells per 10 minutes for the review.

82. The method of claim 54, further comprising altering one or more parameters of said focusing, said generating, or said focusing and said generating, generating additional output responsive to light from only a portion of all of the cells with the one or more altered parameters, wherein the portion of all of the cells was selected for review, and determining one or more additional characteristics of the portion of all of the cells based on the additional output.

83. The method of claim 54, wherein said focusing and said generating are performed with a cell inspection subsystem, and wherein the method further comprises: generating additional output responsive to additional light from the cells and the features with a cell review subsystem having one or more parameters that are different than one or more parameters used for said focusing and generating the output; and determining one or more additional characteristics of the cells based on the additional output.

84. The method of claim 54, wherein said focusing and said generating are performed for all of the cells within the device a first time and then said focusing and said generating are performed for all of the cells within the device a second time.

85. The method of claim 84, wherein one or more parameters of said focusing, said generating, or said focusing and said generating are altered between performing said focusing and said generating the first time and the second time.

86. The method of claim 54, further comprising selecting one or more of the cells for removal from the device based on the one or more characteristics.

87. The method of claim 54, further comprising removing only a portion of the cells for analysis, processing, or growth external to the device.

88. The method of claim 54, further comprising removing only a portion of the cells by coring one or more materials that immobilize the cells within the device with a needle.

89. The method of claim 54, further comprising positioning a cell removal device proximate to one of the cells that has been selected for removal from the device based on additional output generated by imaging the one of the cells.

90. The method of claim 54, wherein one or more materials immobilize the cells in the device, the method further comprising removing only a portion of the cells by directing light to a portion of the one or more materials that immobilize only the portion of the cells to alter flow characteristics of the portion of the one or more materials and aspirating the portion of the one or more materials containing only the portion of the cells.

91. The method of claim 54, wherein one or more materials immobilize the cells in the device, the method further comprising removing only a portion of the cells by directing light to a portion of the one or more materials that immobilize only the portion of the cells to release the portion of the cells from the portion of the one or more materials and aspirating only the released portion of the cells.

92. The method of claim 54, further comprising selecting only a portion of the cells for treatment based on the one or more characteristics.

93. The method of claim 54, further comprising treating only a portion of the cells in the device with one or more reagents.

94. The method of claim 54, further comprising treating one or more of the cells in the device with one or more reagents, wherein said focusing and said generating are performed on the one or more of the cells before and after said treating.

95. The method of claim 54, further comprising stimulating one or more of the cells in the device with one or more stimuli, wherein said focusing and said generating are performed on the one or more of the cells before and after said stimulating.

96. A device configured to immobilize cells for analysis, comprising:
a substrate configured to support one or more materials configured to immobilize the cells within the device;
features configured for use by an analysis system for separately determining and tracking positions of each of the cells in the device on a cell-by-cell basis, wherein the substrate and the one or more materials are further configured to not optically interfere with light focused to the cells and the features by the analysis system and light from the cells and the features detected by the analysis system; and
one or more structures configured to couple an environmental control subsystem to the device, wherein the environmental control subsystem is configured to control an environment of the cells within the device while the device is positioned in the analysis system without altering the positions of the cells within the device.

97. The device of claim 96, wherein the environmental control subsystem is further configured to control the environment by altering or maintaining one or more characteristics of a fluid environment of the cells.

98. The device of claim 96, wherein the substrate and the one or more materials are further configured to allow substantially high resolution imaging of the cells within the device.

99. The device of claim 96, wherein information for the positions of the cells within the device is recorded and maintained by the analysis system.

100. The device of claim 96, wherein the substrate is coupled to one or more additional structures configured to, with the substrate, contain a suspension of the cells and one or more pre-cursor materials, and wherein the one or more pre-cursor materials comprise a polymer solution that forms a gel upon treatment to form the one or more materials that immobilize the cells within the device.

101. The device of claim 96, wherein the substrate is coupled to one or more additional structures configured to, with the substrate, receive an injection of a suspension of the cells and to substantially evenly disperse the cells within the device.

102. The device of claim 96, wherein the cells are not immobilized in individual containers within the device.

103. The device of claim 96, further comprising a hard gel layer formed on the substrate under the one or more materials.

104. The device of claim 96, further comprising a hard gel layer formed on the substrate under the one or more materials, wherein the one or more materials comprise a soft gel, and wherein portions of the soft gel and the hard gel layer are removed by coring during cell removal from the device.

105. The device of claim 96, further comprising a spacer coupled to the substrate and forming an outer wall of the device, wherein the one or more materials are located within the outer wall.

106. The device of claim 96, further comprising one or more removable structures positioned on a spacer coupled to the substrate, wherein the spacer forms an outer wall of the device, and wherein the one or more removable structures comprise a port through which a suspension containing the cells and the one or more materials is injected into the device.

107. The device of claim 96, wherein the one or more structures comprise a flow cell gasket placed above the one or more materials in which the cells are immobilized.

108. The device of claim 96, wherein the one or more materials comprise a collection of cell adhesion spots formed on the substrate.

109. The device of claim 96, further comprising a fluid distribution device coupled to the substrate and comprising a plurality of flow channels through which a suspension of the cells is introduced to the device.

110. The device of claim 96, wherein the one or more materials comprise a collection of cell adhesion spots formed on the substrate, and wherein the cell adhesion spots comprise molecules having a first part that binds the molecules to the substrate and a second part that tethers the cells to the molecules.

111. The device of claim 96, wherein the one or more materials comprise a collection of cell adhesion spots formed on the substrate, and wherein the cell adhesion spots comprise DNA-based linker molecules.

112. The device of claim 96, wherein the one or more materials comprise a collection of cell adhesion spots formed on the substrate, and wherein the cell adhesion spots comprise adhesion molecules that bind to molecules found in or on membranes of the cells to attach any cell type.

113. The device of claim 96, wherein the one or more materials comprise a collection of cell adhesion spots formed on the substrate, and wherein the cell adhesion spots comprise photo-labile capture molecules.

114. The device of claim 96, wherein the one or more materials comprise a collection of cell adhesion spots substantially uniformly spaced from each other on the substrate.

115. The device of claim 96, wherein the one or more materials comprise a photo-depolymerizeable gel.

116. The device of claim 96, wherein the one or more materials release the cells immobilized therein upon exposure to a predetermined wavelength of light.

117. The device of claim 96, wherein each of the cells are spaced from each other within the device.

118. The device of claim 96, wherein the one or more materials comprise an optically clear plate having a regular array of depressions formed in the plate into which the cells in a suspension can settle with each of the cells in one of the depressions.

119. The device of claim 96, wherein the device is further configured to have more than 100,000 cells immobilized therein at any one time.

120. The device of claim 96, wherein the one or more structures comprise a flow cell constructed over the cells prior to, during, or after imaging of the cells, and wherein the environmental control subsystem is further configured to couple to and operate the flow cell prior to, during, or after the imaging of the cells.

121. The device of claim 120, wherein the flow cell is a thin layer of fluid.

122. The device of claim 120, wherein the flow cell is a thin layer of fluid having laminar flow characteristics.

123. The device of claim 120, wherein the flow cell is further constructed using replaceable gaskets.

124. The device of claim 120, wherein the flow cell is further constructed by removing a portion of the device to expose the one or more materials.
